(19) United States
(12) Patent Application Publication
(10) Pub. No.: US 2023/0325665 A1
(43) Pub. Date: Oct. 12, 2023

(54) SPARSITY-BASED REDUCTION OF GATE SWITCHING IN DEEP NEURAL NETWORK ACCELERATORS

(71) Applicant: Intel Corporation, Santa Clara, CA (US)

(72) Inventors: Martin Langhammer, Alderbury (GB); Arnab Raha, San Jose, CA (US); Martin Power, Dublin (IE)

(73) Assignee: Intel Corporation, Santa Clara, CA (US)

(21) Appl. No.: 18/325,298

(22) Filed: May 30, 2023

(51) Int. Cl. G06N 3/08; G06N 3/0464

(52) U.S. Cl. CPC G06N 3/08; G06N 3/0464

(57) ABSTRACT

Gate switching in deep learning operations can be reduced based on sparsity in the input data. A first element of an activation operand and a first element of a weight operand may be stored in input storage units associated with a multiplier in a processing element. The multiplier computes a product of the two elements, which may be stored in an output storage unit of the multiplier. After detecting that a second element of the activation operand or a second element of the weight operand is zero valued, gate switching is reduced by avoiding at least one gate switching needed for the multiply-accumulation operation. For instance, the input storage units may not be updated. A zero-valued data element may be stored in the output storage unit of the multiplier and used as a product of the second element of the activation operand and the second element of the weight operand.

### TECHNICAL FIELD

This disclosure relates generally to deep neural networks (DNNs), and more specifically, sparsity-based reduction of gate switching in DNN accelerators.

### BACKGROUND

DNNs are used extensively for a variety of artificial intelligence applications ranging from computer vision to speech recognition and natural language processing due to their ability to achieve high accuracy. However, the high accuracy comes at the expense of significant computation cost. DNNs have extremely high computing demands as each inference can require hundreds of millions of MAC (multiply-accumulate) operations as well as a large amount of data to read and write. Therefore, techniques to improve efficiency of DNNs are needed.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

Figure (FIG. ) 1 illustrates an example DNN, in accordance with various embodiments.

FIG. 2 illustrates an example convolution, in accordance with various embodiments.

FIG. 3 is a block diagram of a DNN accelerator, in accordance with various embodiments.

FIG. 4 is a block diagram of a compute block, in accordance with various embodiments.

FIG. 5 illustrates sparsity acceleration in an MAC operation by a processing element (PE), in accordance with various embodiments.

FIG. 6 illustrates a PE capable of reducing gate switching based on sparsity, in accordance with various embodiments.

FIG. 7 illustrates a PE with a pipelined multiplier, in accordance with various embodiments.

FIG. 8 illustrates a PE with a multiplier and an accumulator, in accordance with various embodiments.

FIG. 9 illustrates a PE with an accumulator having a register that is configurable based on sparsity, in accordance with various embodiments.

FIG. 10 illustrates a PE with an adder tree, in accordance with various embodiments.

FIG. 11 illustrates a PE array, in accordance with various embodiments.

FIG. 12 is a block diagram of a PE, in accordance with various embodiments.

FIG. 13 is a flowchart showing a method of reducing power consumption for DNNs based on sparsity, in accordance with various embodiments.

FIG. 14 is a block diagram of an example computing device, in accordance with various embodiments.

### DETAILED DESCRIPTION

### Overview

The last decade has witnessed a rapid rise in Al (artificial intelligence) based data processing, particularly based on DNNs. DNNs are widely used in the domains of computer vision, speech recognition, image, and video processing mainly due to their ability to achieve beyond human-level accuracy. The significant improvements in DNN model size and accuracy coupled with the rapid increase in computing power of execution platforms have led to the adoption of DNN applications even within resource constrained mobile and edge devices that have limited energy availability.

A DNN layer may include one or more deep learning operations, such as convolution, pooling, elementwise operation, linear operation, nonlinear operation, and so on. A deep learning operation in a DNN layer may be performed on one or more internal parameters of the DNN layer and input data received by the DNN layer. The internal parameters (e.g., weights) of a DNN layer may be determined during the training phase.

The internal parameters or input data of a DNN layer may be elements of a tensor. A tensor is a data structure having multiple elements across one or more dimensions. Example tensors include a vector, which is a one-dimensional tensor, and a matrix, which is a two-dimensional tensor. There can also be three-dimensional tensors and even higher dimensional tensors. A DNN layer may have an input tensor (also referred to as “input feature map (IFM)”) including one or more input activations (also referred to as “input elements” or “activations”), a weight tensor including one or more weights, and an output tensor (also referred to as “output feature map (OFM)”) including one or more output activations (also referred to as “output elements” or “activations”). A weight tensor of a convolution may be a kernel, a filter, or a group of filters.

An accelerator for executing DNNs (“DNN accelerator”) may include one or more large arrays of PEs which operate concurrently in executing the layers in a DNN. The PEs may perform deep learning operations. For instance, for a convolution, the PEs can perform MAC operations on activation and weights. Input tensors or weight tensors can include zero valued elements. For instance, the training phase can generate zero-valued weights. Highly sparse weights can cause activations to become sparse in later layers of the DNN after they go through nonlinear activation functions, such as rectified linear unit (REL). Network quantization for running inference on edge devices also results in high number of zeros in weight and activations. Zero-valued activations or weights do not contribute towards partial sum accumulation during MAC operations. DNN accelerators can leverage the sparsity available in weights and activations to accelerate deep learning operations in DNNs, which can lead to higher speedup or throughput as well as less power consumption.

Embodiments of the present disclosure can facilitate significant power savings by disabling MAC computation logic in DNN accelerators. For instance, gate switching in PEs can be reduced based on sparsity in weights or activations without impacting the accuracy in the outputs of the PEs.

In various embodiments, a DNN accelerator may include one or more compute blocks for executing deep learning operations in DNNs. A compute block may include an array of PEs. A PE may include one or more multipliers, one or more accumulators, and a plurality of storage units (e.g., registers, etc.). One or more PEs in the compute block may be associated with a sparsity module that can accelerate deep learning operations and reduce power consumed by deep learning operations based on sparsity in activations or weights.

In some embodiments, a multiplier may receive an activation operand comprising a sequence of activations and a weight operand comprising a sequence of weights. The multiplier may perform a sequence of multiplications, each of which is on a respective activation-weight pair. An activation-weight pair includes an activation in the activation operand and a corresponding weight in the weight operand. The position of the activation in the activation operand may be the same as the position of the weight in the weight operand. In some embodiments, the multiplier may be associated with a clock. Each multiplication may be performed within a single clock cycle. For each multiplication round, the sparsity module may determine whether the activation or weight is zero valued. The sparsity module may include one or more logical operators, such as NOR gates.

In embodiments where the sparsity module determines that neither the activation nor the weight is zero valued, the activation and weight are stored in input registers of the multiplier and replace the activation and weight from the previous round. The multiplier may receive the activation and weight from the input registers and computes a product of the activation and weight, and the product is stored in an output register of the multiplier. In embodiments where the sparsity module determines that the activation or weight is zero valued, the sparsity module prevents the activation or weight from entering the input registers of the multiplier. The activation and weight from the previous round may remain in the input registers. The sparsity module may zero the output of the multiplier. This way, less gate switching is needed, compared with having the register storing the activation and weight and having the multiplier computing the zero valued product. In embodiments where the multiplier is pipelined, the sparsity module may delay the zeroing signal by the number of pipes in the multiplier. In addition or alternative to zeroing the output of the multiplier, the sparsity module may zero an input of an accumulator that is configured to accumulate products computed by the multiplier(s) or disable the accumulator for this round, which can reduce the gate switching in the accumulator.

The sparsity module may support integer quantization of floating-point values, such as symmetric quantization, asymmetric quantization, and so on. The sparsity module may also facilitate pattern-based gating, e.g., for elementwise operations. The sparsity module can reduce power consumption for non-zero redundant computations. For instance, the sparsity module may treat a denormal value or a value below a threshold number as zero in some embodiments. The present disclosure provides an approach that can significantly reduce the power consumption of DNN accelerators for DNN training and inference. Delivering high system performance at lower energy in DNN accelerators can be important to efficient edge inference for various Al applications, such as imaging, video, speech, or other applications.

For purposes of explanation, specific numbers, materials and configurations are set forth in order to provide a thorough understanding of the illustrative implementations. However, it will be apparent to one skilled in the art that the present disclosure may be practiced without the specific details or/and that the present disclosure may be practiced with only some of the described aspects. In other instances, well known features are omitted or simplified in order not to obscure the illustrative implementations.

Further, references are made to the accompanying drawings that form a part hereof, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A or B” means (A), (B), or (A and B). For the purposes of the present disclosure, the phrase “A, B, or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/- 20% of a target value based on a particular value as described herein or as known in the art. Similarly, terms indicating orientation of various elements, e.g., “coplanar,” “perpendicular,” “orthogonal,” “parallel,” or any other angle between the elements, generally refer to being within +/- 5-20% of a target value based on a particular value as described herein or as known in the art.

In addition, the terms “comprise,” “comprising,” “include,” “including,” “have,” “having” or any other variation thereof, are intended to cover a non-exclusive inclusion. For example, a method, process, device, or DNN accelerator that comprises a list of elements is not necessarily limited to only those elements but may include other elements not expressly listed or inherent to such method, process, device, or DNN accelerators. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description below and the accompanying drawings.

### Example DNN

FIG. 1 illustrates an example DNN 100, in accordance with various embodiments. For the purpose of illustration, the DNN 100 in FIG. 1 is a CNN. In other embodiments, the DNN 100 may be other types of DNNs. The DNN 100 is trained to receive images and output classifications of objects in the images. In the embodiments of FIG. 1, the DNN 100 receives an input image 105 that includes objects 115, 125, and 135. The DNN 100 includes a sequence of layers comprising a plurality of convolutional layers 110 (individually referred to as “convolutional layer 110”), a plurality of pooling layers 120 (individually referred to as “pooling layer 120”), and a plurality of fully connected layers 130 (individually referred to as “fully connected layer 130”). In other embodiments, the DNN 100 may include fewer, more, or different layers. In an inference of the DNN 100, the layers of the DNN 100 execute tensor computation that includes many tensor operations, such as convolution (e.g., multiply-accumulate (MAC) operations, etc.), pooling operations, elementwise operations (e.g., elementwise addition, elementwise multiplication, etc.), other types of tensor operations, or some combination thereof.

The convolutional layers 110 summarize the presence of features in the input image 105. The convolutional layers 110 function as feature extractors. The first layer of the DNN 100 is a convolutional layer 110. In an example, a convolutional layer 110 performs a convolution on an input tensor 140 (also referred to as IFM 140) and a filter 150. As shown in FIG. 1, the IFM 140 is represented by a 7×7×3 three-dimensional (3D) matrix. The IFM 140 includes 3 input channels, each of which is represented by a 7×7 two-dimensional (2D) matrix. The 7×7 2D matrix includes 7 input elements (also referred to as input points) in each row and 7 input elements in each column. The filter 150 is represented by a 3×3×3 3D matrix. The filter 150 includes 3 kernels, each of which may correspond to a different input channel of the IFM 140. A kernel is a 2D matrix of weights, where the weights are arranged in columns and rows. A kernel can be smaller than the IFM. In the embodiments of FIG. 1, each kernel is represented by a 3×3 2D matrix. The 3×3 kernel includes 3 weights in each row and 3 weights in each column. Weights can be initialized and updated by backpropagation using gradient descent. The magnitudes of the weights can indicate importance of the filter 150 in extracting features from the IFM 140.

The convolution includes MAC operations with the input elements in the IFM 140 and the weights in the filter 150. The convolution may be a standard convolution 163 or a depthwise convolution 183. In the standard convolution 163, the whole filter 150 slides across the IFM 140. All the input channels are combined to produce an output tensor 160 (also referred to as output feature map (OFM) 160). The OFM 160 is represented by a 5×5 2D matrix. The 5×5 2D matrix includes 5 output elements (also referred to as output points) in each row and 5 output elements in each column. For the purpose of illustration, the standard convolution includes one filter in the embodiments of FIG. 1. In embodiments where there are multiple filters, the standard convolution may produce multiple output channels in the OFM 160.

The multiplication applied between a kernel-sized patch of the IFM 140 and a kernel may be a dot product. A dot product is the elementwise multiplication between the kernel-sized patch of the IFM 140 and the corresponding kernel, which is then summed, always resulting in a single value. Because it results in a single value, the operation is often referred to as the “scalar product.” Using a kernel smaller than the IFM 140 is intentional as it allows the same kernel (set of weights) to be multiplied by the IFM 140 multiple times at different points on the IFM 140. Specifically, the kernel is applied systematically to each overlapping part or kernel-sized patch of the IFM 140, left to right, top to bottom. The result from multiplying the kernel with the IFM 140 one time is a single value. As the kernel is applied multiple times to the IFM 140, the multiplication result is a 2D matrix of output elements. As such, the 2D output matrix (i.e., the OFM 160) from the standard convolution 163 is referred to as an OFM.

In the depthwise convolution 183, the input channels are not combined. Rather, MAC operations are performed on an individual input channel and an individual kernel and produce an output channel. As shown in FIG. 1, the depthwise convolution 183 produces a depthwise output tensor 180. The depthwise output tensor 180 is represented by a 5×5×3 3D matrix. The depthwise output tensor 180 includes 3 output channels, each of which is represented by a 5×5 2D matrix. The 5×5 2D matrix includes 5 output elements in each row and 5 output elements in each column. Each output channel is a result of MAC operations of an input channel of the IFM 140 and a kernel of the filter 150. For instance, the first output channel (patterned with dots) is a result of MAC operations of the first input channel (patterned with dots) and the first kernel (patterned with dots), the second output channel (patterned with horizontal strips) is a result of MAC operations of the second input channel (patterned with horizontal strips) and the second kernel (patterned with horizontal strips), and the third output channel (patterned with diagonal stripes) is a result of MAC operations of the third input channel (patterned with diagonal stripes) and the third kernel (patterned with diagonal stripes). In such a depthwise convolution, the number of input channels equals the number of output channels, and each output channel corresponds to a different input channel. The input channels and output channels are referred to collectively as depthwise channels. After the depthwise convolution, a pointwise convolution 193 is then performed on the depthwise output tensor 180 and a 1×1×3 tensor 190 to produce the OFM 160.

The OFM 160 is then passed to the next layer in the sequence. In some embodiments, the OFM 160 is passed through an activation function. An example activation function is Reu. Elu is a calculation that returns the value provided as input directly, or the value zero if the input is zero or less. The convolutional layer 110 may receive several images as input and calculate the convolution of each of them with each of the kernels. This process can be repeated several times. For instance, the OFM 160 is passed to the subsequent convolutional layer 110 (i.e., the convolutional layer 110 following the convolutional layer 110 generating the OFM 160 in the sequence). The subsequent convolutional layers 110 perform a convolution on the OFM 160 with new kernels and generates a new feature map. The new feature map may also be normalized and resized. The new feature map can be kernelled again by a further subsequent convolutional layer 110, and so on.

In some embodiments, a convolutional layer 110 has 4 hyperparameters: the number of kernels, the size F kernels (e.g., a kernel is of dimensions F×F×D pixels), the S step with which the window corresponding to the kernel is dragged on the image (e.g., a step of one means moving the window one pixel at a time), and the zero-padding P (e.g., adding a black contour of P pixels thickness to the input image of the convolutional layer 110). The convolutional layers 110 may perform various types of convolutions, such as 2-dimensional convolution, dilated or atrous convolution, spatial separable convolution, depthwise separable convolution, transposed convolution, and so on. The DNN 100 includes 16 convolutional layers 110. In other embodiments, the DNN 100 may include a different number of convolutional layers.

The pooling layers 120 down-sample feature maps generated by the convolutional layers, e.g., by summarizing the presence of features in the patches of the feature maps. A pooling layer 120 is placed between 2 convolution layers 110: a preceding convolutional layer 110 (the convolution layer 110 preceding the pooling layer 120 in the sequence of layers) and a subsequent convolutional layer 110 (the convolution layer 110 subsequent to the pooling layer 120 in the sequence of layers). In some embodiments, a pooling layer 120 is added after a convolutional layer 110, e.g., after an activation function (e.g., ReLU) has been applied to the OFM 160.

A pooling layer 120 receives feature maps generated by the preceding convolution layer 110 and applies a pooling operation to the feature maps. The pooling operation reduces the size of the feature maps while preserving their important characteristics. Accordingly, the pooling operation improves the efficiency of the DNN and avoids over-learning. The pooling layers 120 may perform the pooling operation through average pooling (calculating the average value for each patch on the feature map), max pooling (calculating the maximum value for each patch of the feature map), or a combination of both. The size of the pooling operation is smaller than the size of the feature maps. In various embodiments, the pooling operation is 2×2 pixels applied with a stride of 2 pixels, so that the pooling operation reduces the size of a feature map by a factor of 2, e.g., the number of pixels or values in the feature map is reduced to one quarter the size. In an example, a pooling layer 120 applied to a feature map of 6×6 results in an output pooled feature map of 3×3. The output of the pooling layer 120 is inputted into the subsequent convolution layer 110 for further feature extraction. In some embodiments, the pooling layer 120 operates upon each feature map separately to create a new set of the same number of pooled feature maps.

The fully connected layers 130 are the last layers of the DNN. The fully connected layers 130 may be convolutional or not. The fully connected layers 130 receive an input operand. The input operand defines the output of the convolutional layers 110 and pooling layers 120 and includes the values of the last feature map generated by the last pooling layer 120 in the sequence. The fully connected layers 130 apply a linear combination and an activation function to the input operand and generate a vector. The vector may contain as many elements as there are classes: element i represents the probability that the image belongs to class i. Each element is therefore between 0 and 1, and the sum of all is worth one. These probabilities are calculated by the last fully connected layer 130 by using a logistic function (binary classification) or a softmax function (multi-class classification) as an activation function.

In some embodiments, the fully connected layers 130 classify the input image 105 and return an operand of size N, where N is the number of classes in the image classification problem. In the embodiments of FIG. 1, N equals 3, as there are 3 objects 115, 125, and 135 in the input image. Each element of the operand indicates the probability for the input image 105 to belong to a class. To calculate the probabilities, the fully connected layers 130 multiply each input element by weight, make the sum, and then apply an activation function (e.g., logistic if N=2, softmax if N>2). This is equivalent to multiplying the input operand by the matrix containing the weights. In an example, the vector includes 3 probabilities: a first probability indicating the object 115 being a tree, a second probability indicating the object 125 being a car, and a third probability indicating the object 135 being a person. In other embodiments where the input image 105 includes different objects or a different number of objects, the individual values can be different.

### Example Convolution

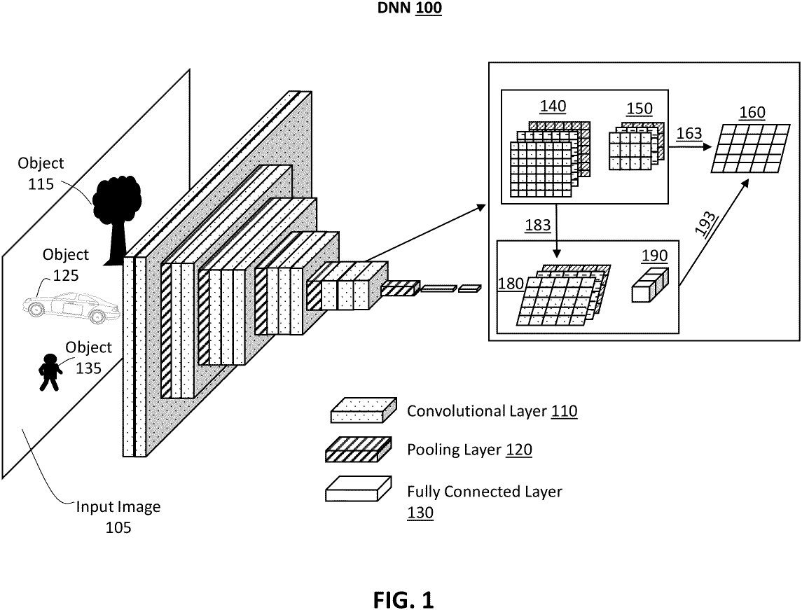

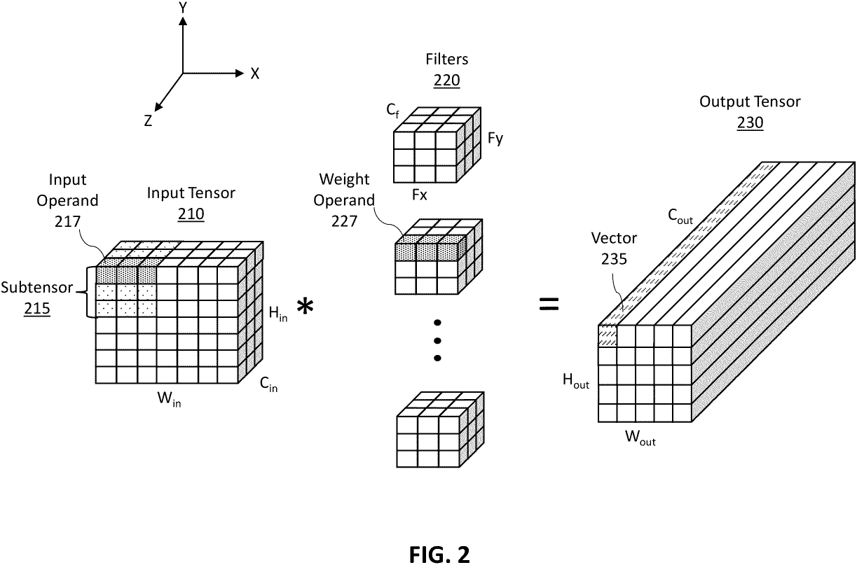

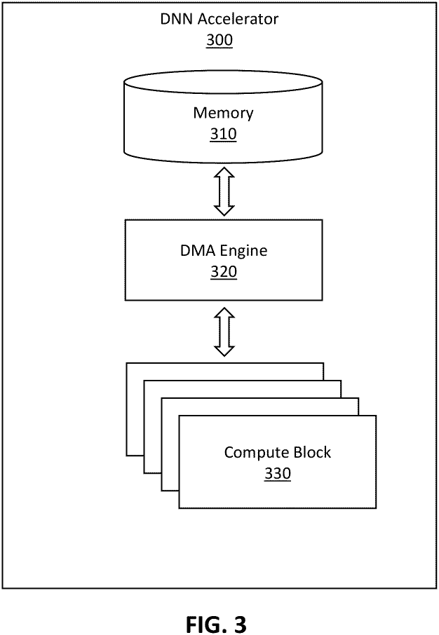

FIG. 2 illustrates an example convolution, in accordance with various embodiments. The convolution may be a convolution in a convolutional layer of a DNN, e.g., a convolutional layer 110 in FIG. 1. The convolutional layer may be a frontend layer. The convolution can be executed on an input tensor 210 and filters 220 (individually referred to as “filter 220”). A result of the convolution is an output tensor 230. In some embodiments, the convolution is performed by a DNN accelerator including one or more compute block. An example of the DNN accelerator may be the DNN accelerator 300 in FIG. 3. Examples of the compute blocks may be the compute blocks 325 in FIG. 3.

In the embodiments of FIG. 2, the input tensor 210 includes activations (also referred to as “input activations,” “elements,” or “input elements”) arranged in a 3D matrix. An activation in the input tensor 210 is a data point in the input tensor 210. The input tensor 210 has a spatial size Hᵢₙ × Wᵢₙ × Cᵢₙ, where Hᵢₙ is the height of the 3D matrix (i.e., the length along the Y axis, which indicates the number of activations in a column in the 2D matrix of each input channel), Wᵢₙ is the width of the 3D matrix (i.e., the length along the X axis, which indicates the number of activations in a row in the 2D matrix of each input channel), and Cᵢₙ is the depth of the 3D matrix (i.e., the length along the Z axis, which indicates the number of input channels). For purpose of simplicity and illustration, the input tensor 210 has a spatial size of 7×7×3, i.e., the input tensor 210 includes three input channels and each input channel has a 7×7 2D matrix. Each input element in the input tensor 210 may be represented by a (X, Y, Z) coordinate. In other embodiments, the height, width, or depth of the input tensor 210 may be different.

Each filter 220 includes weights arranged in a 3D matrix. The values of the weights may be determined through training the DNN. A filter 220 has a spatial size H_{f} × W_{f} × C_{f}, where H_{f} is the height of the filter (i.e., the length along the Y axis, which indicates the number of weights in a column in each kernel), W_{f} is the width of the filter (i.e., the length along the X axis, which indicates the number of weights in a row in each kernel), and C_{f} is the depth of the filter (i.e., the length along the Z axis, which indicates the number of channels). In some embodiments, C_{f} equals Cᵢₙ. For purpose of simplicity and illustration, each filter 220 in FIG. 2 has a spatial size of 3×3×3, i.e., the filter 220 includes 3 convolutional kernels with a spatial size of 3×3. In other embodiments, the height, width, or depth of the filter 220 may be different. The spatial size of the convolutional kernels is smaller than the spatial size of the 2D matrix of each input channel in the input tensor 210.

An activation or weight may take one or more bytes in a memory. The number of bytes for an activation or weight may depend on the data format. For example, when the activation or weight has an integral format (e.g., INT8), the activation takes one byte. When the activation or weight has a floating-point format (e.g., FP16 or BF16), the activation or weight takes two bytes. Other data formats may be used for activations or weights.

In the convolution, each filter 220 slides across the input tensor 210 and generates a 2D matrix for an output channel in the output tensor 230. In the embodiments of FIG. 2, the 2D matrix has a spatial size of 5×5. The output tensor 230 includes activations (also referred to as “output activations,” “elements,” or “output element”) arranged in a 3D matrix. An activation in the output tensor 230 is a data point in the output tensor 230. The output tensor 230 has a spatial size Hₒᵤₜ × Wₒᵤₜ × Cₒᵤₜ, where Hₒᵤₜ is the height of the 3D matrix (i.e., the length along the Y axis, which indicates the number of output activations in a column in the 2D matrix of each output channel), Wₒᵤₜ is the width of the 3D matrix (i.e., the length along the X axis, which indicates the number of output activations in a row in the 2D matrix of each output channel), and Cₒᵤₜ is the depth of the 3D matrix (i.e., the length along the Z axis, which indicates the number of output channels). Cₒᵤₜ may equal the number of filters 220 in the convolution. Hₒᵤₜ and Wₒᵤₜ may depend on the heights and weights of the input tensor 210 and each filter 220.

As a part of the convolution, MAC operations can be performed on a 3×3×3 subtensor 215 (which is highlighted with dot patterns in FIG. 2) in the input tensor 210 and each filter 220. The result of the MAC operations on the subtensor 215 and one filter 220 is an output activation. In some embodiments (e.g., embodiments where the convolution is an integral convolution), an output activation may include 8 bits, e.g., one byte. In other embodiments (e.g., embodiments where the convolution is a floating-point convolution), an output activation may include more than one byte. For instance, an output element may include two bytes.

After the MAC operations on the subtensor 215 and all the filters 220 are finished, a vector 235 is produced. The vector 235 is highlighted with slashes in FIG. 2. The vector 235 includes a sequence of output activations, which are arranged along the Z axis. The output activations in the vector 235 have the same (x, y) coordinate, but the output activations correspond to different output channels and have different Z coordinates. The dimension of the vector 235 along the Z axis may equal the total number of output channels in the output tensor 230.

After the vector 235 is produced, further MAC operations are performed to produce additional vectors till the output tensor 230 is produced. For instance, a filter 220 may move over the input tensor 210 along the X axis or the Y axis, and MAC operations can be performed on the filter 220 and another subtensor in the input tensor 210 (the subtensor has the same size as the filter 220). The amount of movement of a filter 220 over the input tensor 210 during different compute rounds of the convolution is referred to as the stride size of the convolution. The stride size may be 1 (i.e., the amount of movement of the filter 220 is one activation), 2 (i.e., the amount of movement of the filter 220 is two activations), and so on. The height and width of the output tensor 230 may be determined based on the stride size.

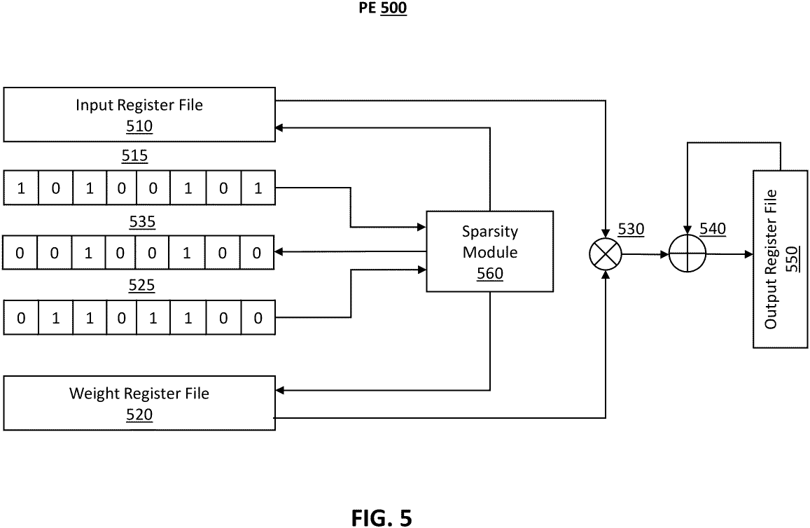

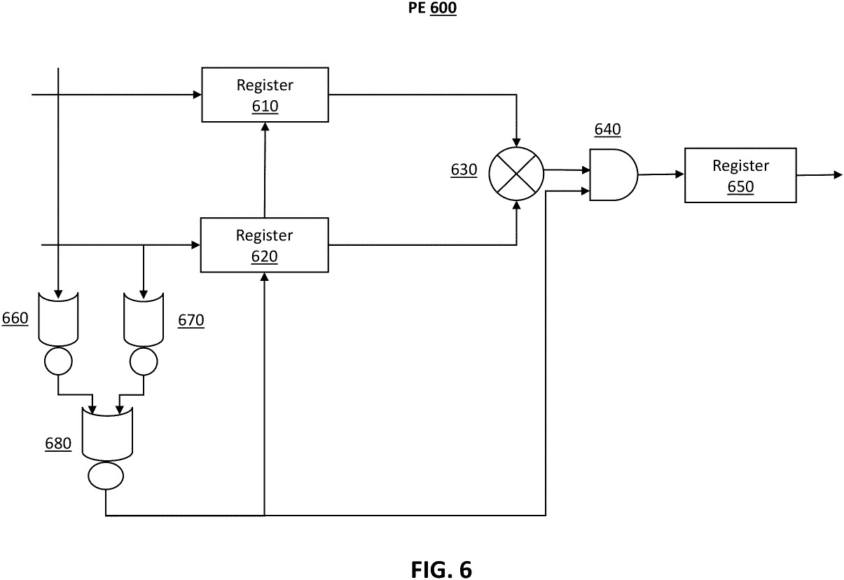

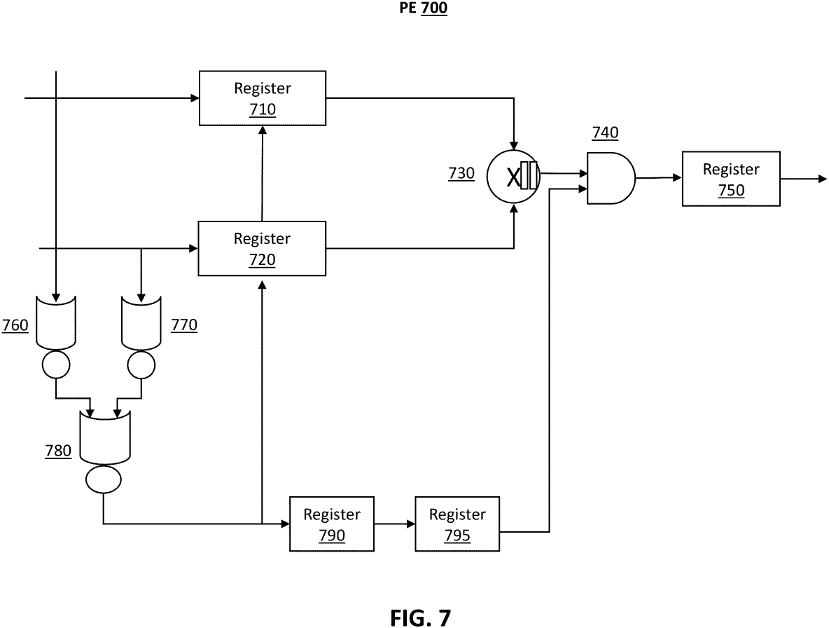

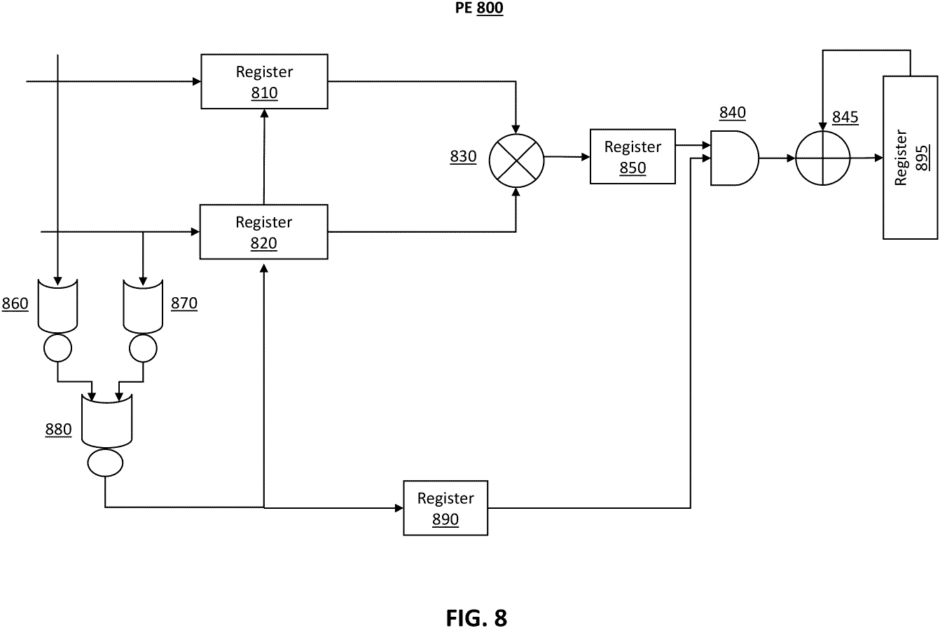

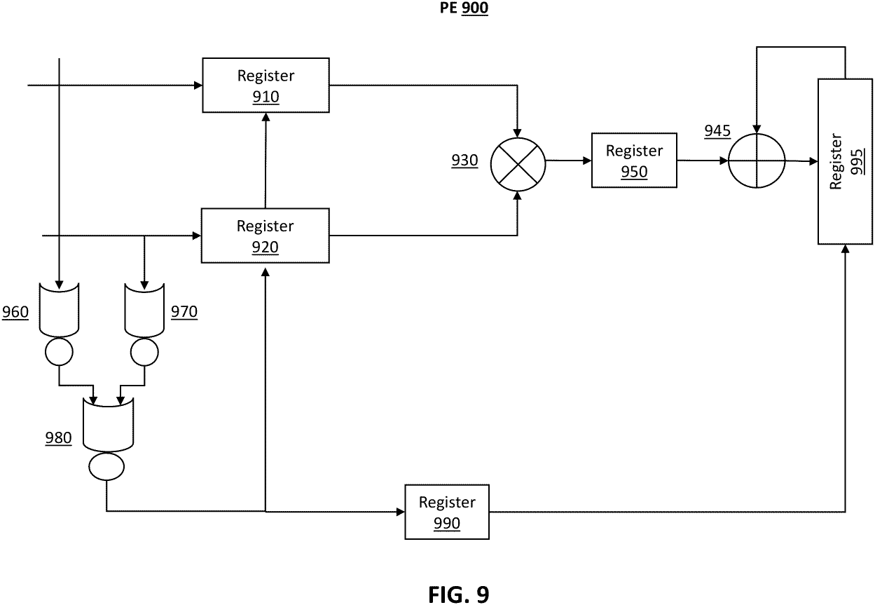

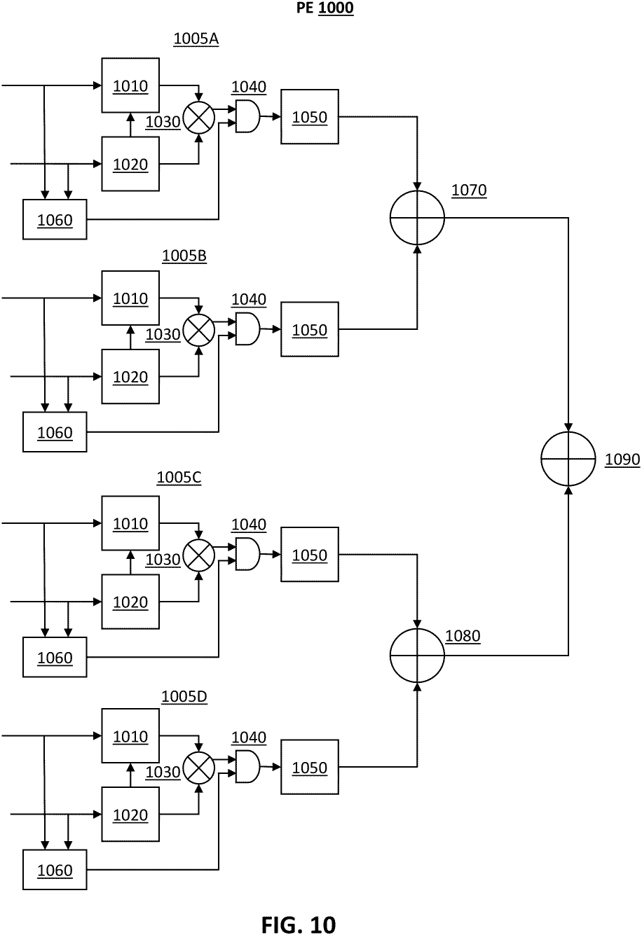

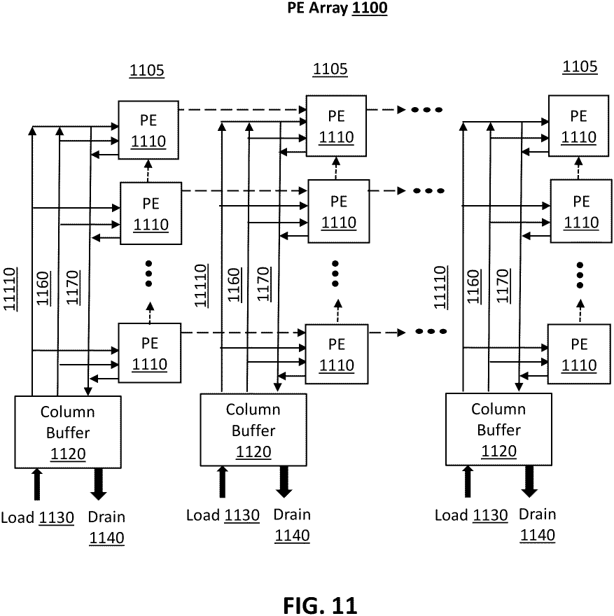

In some embodiments, the MAC operations on a 3×3×3 subtensor (e.g., the subtensor 215) and a filter 220 may be performed by a plurality of PEs, such as the PE 500 in FIG. 5, the PE 600 in FIG. 6, the PE 700 in FIG. 7, the PE 800 in FIG. 8, the PE 900 in FIG. 9, the PE 1000 in FIG. 10, or the PEs 1110 in FIG. 11. One or more MAC units may receive an activation operand (e.g., an activation operand 217 shown in FIG. 2) and a weight operand (e.g., the weight operand 227 shown in FIG. 2). The activation operand 217 includes a sequence of activations having the same (Y, Z) coordinate but different X coordinates. The weight operand 227 includes a sequence of weights having the same (Y, Z) coordinate but different X coordinates. The length of the activation operand 217 is the same as the length of the weight operand 227. Activations in the activation operand 217 and weights in the weight operand 227 may be sequentially fed into a PE. The PE may receive a pair of an activation and a weight at a time and multiple the activation and the weight. The position of the activation in the activation operand 217 may match the position of the weight in the weight operand 227.

### Example DNN Accelerator

FIG. 3 is a block diagram of a DNN accelerator 300, in accordance with various embodiments. The DNN accelerator 300 can run DNNs, e.g., the DNN 100 in FIG. 1. The DNN accelerator 300 includes a local memory 410, a DMA (direct memory access) engine 320, and compute blocks 330. In other embodiments, alternative configurations, different or additional components may be included in the DNN accelerator 300. For example, the DNN accelerator 300 may include more than one local memory 410 or more than one DMA engine 320. As another example, the DNN accelerator 300 may include a single compute block 330. Further, functionality attributed to a component of the DNN accelerator 300 may be accomplished by a different component included in the DNN accelerator 300 or by a different system.

The local memory 410 stores data to be used by the compute blocks 330 to perform deep learning operations in DNN models. Example deep learning operations include convolutions (also referred to as “convolutional operations”), pooling operations, elementwise operations, other types of deep learning operations, or some combination thereof. The local memory 410 may be a main memory of the DNN accelerator 300. In some embodiments, the local memory 410 includes one or more DRAMs (dynamic random-access memory). For instance, the local memory 410 may store the input tensor, convolutional kernels, or output tensor of a convolution in a convolutional layer of a DNN, e.g., the convolutional layer 30. The output tensor can be transmitted from a local memory of a compute block 330 to the local memory 410 through the DMA engine 320.

The DMA engine 320 facilitates data transfer between the local memory 410 and local memories of the compute blocks 330. For example, the DMA engine 320 can read data from the local memory 410 and write data into a local memory of a compute block 330. As another example, the DMA engine 320 can read data from a local memory of a compute block 330 and write data into the local memory 410. The DMA engine 320 provides a DMA feature that allows the compute block 330 to initiate data transfer between the local memory 410 and the local memories of the compute blocks 330 and to perform other operations while the data transfer is in being conducted. In some embodiments, the DMA engine 320 may read tensors from the local memory 410, modify the tensors in a way that is optimized for the compute block 330 before it writes the tensors into the local memories of the compute blocks 330.

The compute blocks 330 perform computation for deep learning operations. A compute block 330 may run the operations in a DNN layer, or a portion of the operations in the DNN layer. A compute block 330 may perform convolutions, such as standard convolution (e.g., the standard convolution 163 in FIG. 1), depthwise convolution (e.g., the depthwise convolution 183 in FIG. 1), pointwise convolution (e.g., the pointwise convolution 193 in FIG. 1), and so on. In some embodiments, the compute block 330 receive an input tensor and one or more convolutional kernels and performs a convolution with the input tensor and convolutional kernels. The result of the convolution may be an output tensor, which can be further computed, e.g., by the compute block 330 or another compute block. In some embodiments, the operations of the DNN layers may be run by multiple compute blocks 330 in parallel. For instance, multiple compute blocks 330 may each perform a portion of a workload for a convolution. Data may be shared between the compute blocks 330.

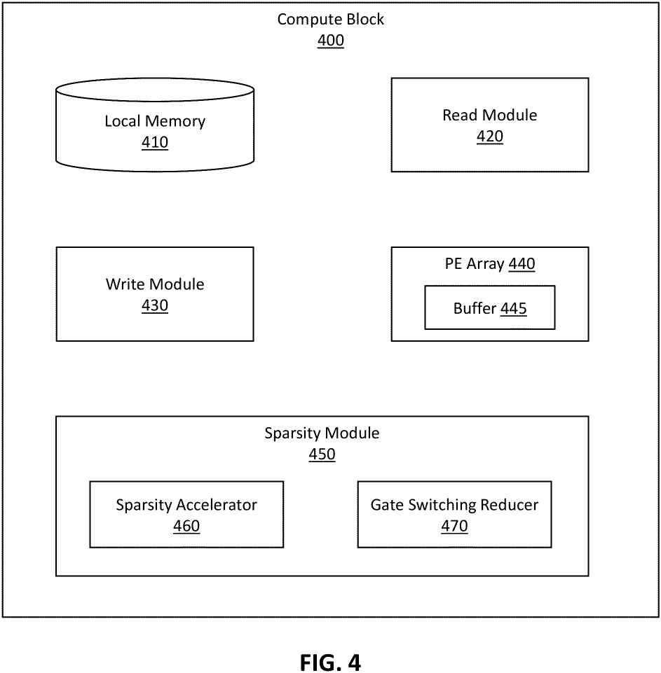

FIG. 4 is a block diagram of a compute block 400, in accordance with various embodiments. The compute block 400 may be an example of the compute block 330 in FIG. 3. As shown in FIG. 4, the compute block 400 includes a local memory 410, a read module 420, a write module 430, a PE array 440, and a sparsity module 450. In other embodiments, alternative configurations, different or additional components may be included in the compute block 400. For instance, the compute block 400 may include more than one local memory 410, PE array 440, or sparsity module 450. Further, functionality attributed to a component of the compute block 400 may be accomplished by a different component included in the compute block 400, another component of the DNN accelerator 300, or by a different system. For example, the buffer 445 may be arranged inside the PE array 440. As another example, at least part of the sparsity module 450 may be implemented in the PE array 440.

The local memory 410 is local to the compute block 400. In the embodiments of FIG. 4, the local memory 410 is inside the compute block 400. In other embodiments, the local memory 410 may be outside the compute block 400. The local memory 410 and the compute block 400 can be implemented on the same chip. The local memory 410 stores data used for or generated from convolutions, e.g., input activations, weights, and output activations. In some embodiments, the local memory 410 includes one or more SRAMs (static random-access memories). The local memory 410 may be byte-addressable, and each memory address identifies a single byte (eight bits) of storage. In some embodiments, the local memory 410 may include banks, each bank may have a capacity of a fixed number of bytes, such as 32, 64, and so on.

In some embodiments, the local memory 410 may include data banks. The number of data banks in the local memory 410 may be 128, 256, 512, 1024, 2048, and so on. A data bank may include a plurality of storage units. In an example, a data bank may include 8, 16, 64, or a different number of storage units. A storage unit may have a memory address. In an example, a storage unit may store a single byte, and data larger than a single byte may be stored in storage units with consecutive memory addresses, i.e., adjacent storage units. For instance, a storage unit can store an integer number in the INT8 format, versus two storage units may be needed to store a number in the FP16 or BF16 format, which has 16 bits. In some embodiments, 16 bits can be transferred from the local memory 410 in a single reading cycle. In other embodiments, 16 bits can be transferred from the local memory 410 in multiple reading cycles, such as two cycles.

The read module 420 reads data (e.g., input activations, weights, etc.) from the local memory 410 into a buffer 445 in the PE array 440. The write module 430 writes data (e.g., output activations, etc.) from the buffer 445 into the local memory 410. The buffer 445 temporarily stores data that is transferred between the local memory 410 and the PE array 440. The buffer 445 can facilitate data transfer between the local memory 410 and the PE array 440 despite a difference between a rate that data can be received and a rate that data can be processed. In some embodiments, the storage capacity of the buffer 445 may be smaller than the storage capacity of the local memory 410. In an example, the buffer 445 includes an array of bytes. The number of bytes in the array may define a width of the buffer 445. The width of the buffer may be 16, 32, 64, 128, and so on.

Data from the buffer 445 may be loaded into the PE array 440 and the data is to be used by the PE array 440 for MAC operations. In some embodiments, input activations may be loaded from the buffer 445 into an input storage unit in the PE array 440. The input storage unit may include one or more register files for storing input activations to be used for MAC operations. Weights may be loaded from the buffer 445 into a weight storage unit in the PE array 440. The weight storage unit may include one or more register files for storing weights to be used for MAC operations. The drain module 350 can transfer data generated by the PE array 440 into the buffer 445. The data maybe results of MAC operations performed by the PE array 440, such as output activations.

The PE array 440 performs MAC operations in convolutions. The PE array 440 may perform other deep learning operations. The PE array 440 may include PEs arranged in columns, or columns and rows. Each PE can perform MAC operations. In some embodiments, a PE includes one or more multipliers for performing multiplications. An PE may also include one or more adders for performing accumulations. A column of PEs is referred to as a PE column. A PE column may be associated with one or more MAC lanes. A MAC lane is a path for loading data into a MAC column. A MAC lane may be also referred to as a data transmission lane or data load lane. A PE column may have multiple MAC lanes. The loading bandwidth of the MAC column is an aggregation of the loading bandwidths of all the MAC lanes associated with the MAC column. With a certain number of MAC lanes, data can be fed into the same number of independent PEs simultaneously. In some embodiments where a MAC column has four MAC lanes for feeding activations or weights into the MAC column and each MAC lane may have a bandwidth of 16 bytes, the four MAC lanes can have a total loading bandwidth of 64 bytes.

In some embodiments, the PE array 440 may be capable of standard convolution, depthwise convolution, pointwise convolution, other types of convolutions, or some combination thereof. In a standard convolution, MAC operations may include accumulations across the channels. For instance, as opposed to generating an output operand, a PE may accumulate products across different channels to generate a single output point.

In a depthwise convolution, a PE may perform an MAC operation that includes a sequence of multiplications for an activation operand (e.g., the activation operand 217) and a weight operand (e.g., the weight operand 227). Each multiplication in the sequence is a multiplication of a different activation in the activation operand with a different weight in the weight operand. The activation and weight in the same cycle may correspond to the same channel. The sequence of multiplication produces a product operand that includes a sequence of products. The MAC operation may also include accumulations in which multiple product operands are accumulated to produce an output operand of the PE. The PE array 440 may output multiple output operands at a time, each of which is generated by a different PE.

In some embodiments, a PE may perform multiple rounds of MAC operations for a convolution. Data (activations, weights, or both) may be reused within a single round, e.g., across different multipliers in the PE, or reused across different rounds of MAC operations.

The sparsity module 450 improves performance and reduces power consumptions of the DNN accelerator 300 based on sparsity in input data (e.g., activations, weights, etc.) of deep learning operations. The sparsity module 450 may have a sparsity acceleration logic that can identify non-zero-valued activation-weight pairs and skips zero-valued activation-weight pairs. A non-zero-valued activation-weight pair includes a non-zero-valued activation and a non-zero-valued weight, while a zero-valued activation-weight pair includes a zero-valued activation or a zero-valued weight. The sparsity module 450 can detect sparsity in activations or weights. In situations where the sparsity module detects a zero-valued activation or weight, the sparsity module 450 may prevent computation on the activation or weight. The sparsity module 450 may also prevent the activation or weight from getting into the registers of the PE to reduce the number of gates switching in the PE.

The sparsity module 450 may be implemented in hardware, software, firmware, or some combination thereof. In some embodiments, at least part of the sparsity module 450 may be inside a PE. Even though FIG. 4 shows a single sparsity module 450, the compute block 400 may include multiple sparsity modules 450. In some embodiments, every PE in the PE array 440 is implemented with a sparsity module 450 for accelerating computation and reducing power consumption in the individual PE. In other embodiments, a subset of the PE array 440 (e.g., a PE column or multiple PE columns in the PE array 440) may be implemented with a sparsity module 450 for acceleration computations in the subset of PEs.

As shown in FIG. 4, the sparsity module 450 includes a sparsity accelerator 460 and a gate switching reducer 470. In other embodiments, alternative configurations, different or additional components may be included in the sparsity module 450. Further, functionality attributed to a component of the sparsity module 450 may be accomplished by a different component included in the sparsity module 450, another component included in the compute block 400, another component of the DNN accelerator 300, or a different system.

The sparsity accelerator 460 accelerates computations in the PE array 440 based on sparsity in input data of the computations. In some embodiments (e.g., embodiments where the compute block 400 executes a convolutional layer), a computation in a PE may be a MAC operation on an activation operand and a weight operand. The activation operand may be a portion of the input tensor of the convolution. The activation operand includes a sequence of input elements, aka activations. The activations may be from different input channels. For instance, each activation is from a different input channel from all the other activations in the activation operand. The activation operand is associated with an activation bitmap (also referred to as “activation sparsity vector”), which may be stored in the local memory 410. The activation bitmap can indicate positions of the non-zero-valued activations in the activation operand. The activation bitmap may include a sequence of bits, each of which corresponds to a respective activation in the activation operand. The position of a bit in the activation bitmap may match the position of the corresponding activation in the activation operand. A bit in the activation bitmap may be zero or one. A zero valued bit indicates that the value of the corresponding activation is zero, a one valued bit indicates that the value of the corresponding activation is non-zero. In some embodiments, the activation bitmap may be generated during the execution of another DNN layer, e.g., a layer that is arranged before the convolutional layer in the DNN.

The weight operand may be a portion of a kernel of the convolution. The weight operand includes a sequence of weights. The values of the weights are determined through training the DNN. The weights in the weight operand may be from different input channels. For instance, each weight is from a different input channel from all the other weights in the weight operand. The weight operand is associated with a weight bitmap (also referred to as “activation sparsity vector”), which may be stored in the local memory 410. The weight bitmap can indicate positions of the non-zero-valued weights in the weight operand. The weight bitmap may include a sequence of bits, each of which corresponds to a respective weight in the weight operand. The position of a bit in the weight bitmap may match the position of the corresponding weight in the weight operand. A bit in the weight bitmap may be zero or one. A zero valued bit indicates that the value of the corresponding weight is zero, a one valued bit indicates that the value of the corresponding weight is non-zero.

The sparsity accelerator 460 may receive the activation bitmap and the weight bitmap and generate a combined sparsity bitmap for the MAC operation to be performed by the PE. In some embodiments, the sparsity accelerator 460 generates the combined sparsity bitmap 735 by performing one or more AND operations on the activation bitmap and the weight bitmap. Each bit in the combined sparsity bitmap is a result of an AND operation on a bit in the activation bitmap and a bit in the weight bitmap, i.e., a product of the bit in the activation bitmap and the bit in the weight bitmap. The position of the bit in the combined sparsity bitmap matches the position of the bit in the activation bitmap and the position of the bit in the weight bitmap. A bit in the combined bitmap corresponds to a pair of activation and weight (activation-weight pair). A zero bit in the combined sparsity bitmap indicates that at least one of the activation and weight in the pair is zero. A one bit in the combined sparsity bitmap indicates that both the activation and weight in the pair are non-zero. The combined sparsity bitmap may be stored in the local memory 410.

The sparsity accelerator 460 may provide activations and weights to the PE based on the combined sparsity bitmap. For instance, the sparsity accelerator 460 may identify one or more non-zero-valued activation-weight pairs from the local memory 410 based on the combined sparsity bitmap. The local memory 410 may store activation operands and weight operands in a compressed format so that non-zero-valued activations and non-zero-valued weights are stored but zero-valued activations and zero-valued weights are not stored. The non-zero-valued activation(s) of an activation operand may constitute a compressed activation operand. The non-zero-valued weight (s) of a weight operand may constitute a compressed weight operand. For a non-zero-valued activation-weight pair, the sparsity accelerator 460 may determine a position the activation in the compressed activation operand and determine a position of the weight in the compressed weight operand based on the activation bitmap, weight bitmap, and the combined bitmap. The activation and weight can be read from the local memory 410 based on the positions determined by the sparsity accelerator 460.

In some embodiments, the sparsity accelerator 460 includes a sparsity acceleration logic that can compute position bitmaps based on the activation bitmap and weight bitmap. The sparsity accelerator 460 may determine position indexes of the activation and weight based on the position bitmaps. In an example, the position index of the activation in the compressed activation operand may equal the number of one(s) in an activation position bitmap generated by the sparsity accelerator 460, and the position index of the weight in the compressed weight operand may equal the number of one(s) in a weight position bitmap generated by the sparsity accelerator 460. The position index of the activation or weight indicates the position of the activation or weight in the compressed activation operand or the compressed weight operand. The sparsity accelerator 460 may read the activation and weight from one or more memories based on their position indexes.

The sparsity accelerator 460 can forward the identified non-zero-valued activation-weight pairs to the PE. The sparsity accelerator 460 may skip the other activations and the other weights, as they will not contribute to the result of the MAC operation. In some embodiments, the local memory 410 may store the non-zero-valued activations and weights and not store the zero-valued activations or weights. The non-zero-valued activations and weights may be loaded to one or more register files of the PE, from which the sparsity accelerator 460 may retrieve the activations and weights corresponding to the ones in the combined sparsity bitmap. In some embodiments, the total number of ones in the combined sparsity bitmap equals the total number of activation-weight pairs that will be computed by the PE, while the PE does not compute the other activation-weight pairs. By skipping the activation-weight pairs corresponding to zero bits in the combined sparsity bitmap, the computation of the PE will be faster, compared with the PE computing all the activation-weight pairs in the activation operand and weight operand.

The gate switching reducer 470 detects zero-valued activations or weights and reduces gate switching in PEs. The gate switching reducer 470 may detect whether an activation or weight is zero valued based on the activation or weight itself or based on a bitmap. The bitmap may be an activation bitmap, weight bitmap, or combined sparsity bitmap, which may be received by the gate switching reducer 470 from the sparsity accelerator 460. In some embodiments, the gate switching reducer 470 includes one or more logical operators, such as logic gates. Examples of the logic gates include NOR gate, OR gate, AND gate, and so on, such as NOR gates shown in FIGS. 6-10. The gate switching reducer 470 may also include one or more data selectors, such as multiplexer (MUX).

In some embodiments, the gate switching reducer 470 may receive the activation and weight that are to be computed, e.g., in a round of operation by a multiplier in a PE. In addition or alternative to receiving the activation and weight, the gate switching reducer 470 may receive a bit in an activation bitmap representing the activation and a bit in a weight bitmap representing the weight. The gate switching reducer 470 may generate a signal indicating whether the activation or weight is zero. In an example, the gate switching reducer 470 may generate a “0” signal when the activation or weight is zero. In another example, the gate switching reducer 470 may generate a “1” signal when neither the activation nor weight is zero.

In other embodiments, the gate switching reducer 470 may determine whether the activation or weight is zero based on a bit in a combined sparsity bitmap. The position of the bit in the combined sparsity bitmap may match (e.g., be the same as) the position of the activation in the activation operand and the position of the weight in the weight operand. The gate switching reducer 470 may determine the activation or weight is zero when the bit in the combined sparsity bitmap is zero. The gate switching reducer 470 may determine the activation and weight are both not zero when the bit in the combined sparsity bitmap is one.

After determining that the activation or weight is zero, the gate switching reducer 470 may prevent the multiplier from processing the activation or weight. In some embodiments, the gate switching reducer 470 may present the activation and weight from getting into the registers of the multiplier so that the registers may keep the activation and weight from the previous round. This can avoid gate switching that is needed for replacing the activation and weight from the previous round with the activation and weight in the current round. The gate switching reducer 470 may zero the output of the multiplier, e.g., by writing a zero-valued data element into the register configured to store the output of the multiplier. Additionally or alternatively, the gate switching reducer 470 may zero the input of the accumulator configured to accumulate multiplier outputs or disable the accumulator for the current round. In some embodiments (e.g., embodiments where the multiplier is pipelined), the gate switching reducer 470 may delay the zeroing signal (e.g., the signal for zeroing the output of the multiplier, for zeroing the input of the accumulator, or for disabling the accumulator), e.g., by the number of pipes in the multiplier. The zeroing signal may be stored in a register during the delay.

In some embodiments, the gate switching reducer 470 may detect non-zero redundant computations. Data Formats, such as floating-point, may have other values apart from zero that produce non-zero computations. For example, floating-point may have infinite (INF) and Not-a-Number (NaN) values. In embodiments where the activation or weight is any of these values, the gate switching reducer 470 may skip these values. The gate switching reducer 470 may make the NaN/INF value (instead of zero) as the output of the multiplier. In some embodiments, denormal values may be treated as zero. The gate switching reducer 470 may determine that an activation or weight having a denormal value is zero valued.

In some embodiments (e.g., embodiments where the activation or weight is a floating number that has been quantized), the gate switching reducer 470 may determine which quantization method (e.g., symmetric quantization, asymmetric quantization, etc.) was used to quantize the activation or weight. The gate switching reducer 470 may determine whether the activation or weight is zero based on the quantization method. In cases where symmetric quantization is used, zero may be represented as zero. In cases where asymmetric quantization is used, a non-zero value may represent the zero value (e.g., a zero point). The gate switching reducer 470 may provide a configurable input to configure what value is considered a zero and could provide a unique value for either weights or activations if needed.

In some embodiments, the gate switching reducer 470 may determine that the activation or weight is zero based on a determination that the value of the activation or weight is lower than a threshold number. In embodiments where the activation or weight is greater than the threshold number, the gate switching reducer 470 may determine that the activation and weight are both non-zero. In an embodiment, the gate switching reducer 470 may use the same threshold number for activations and weights. In another embodiment, the threshold number for activations may be different from the threshold number for weights. The threshold number may be configurable.

In some embodiments, the gate switching reducer 470 may facilitate pattern-based gating. Some deep learning operations may have a single set of inputs provided to a multi-input PE and processed by the PE in accordance with a certain pattern. An example pattern may be one data element at a time. The PE may produce multiple outputs from the single set of input. Examples of such deep learning operations include elementwise operations, such as elementwise accumulation, elementwise multiplication, and so on. The gate switching reducer 470 may provide logic to cycle through patterns (such as a walking one for an elementwise operation) and use this to MUX the output of the multipliers in the PE while maintaining the inputs static and keeping switching activity to a minimum.

### Example Sparsity Acceleration in PE

FIG. 5 illustrates sparsity acceleration in an MAC operation by a PE 500, in accordance with various embodiments. The PE 500 may be a PE in the PE array 440. In the embodiments of FIG. 5, the PE 500 includes an input register file 510, a weight register file 520, a multiplier 530, an accumulator 540, and an output register file 550. In other embodiments, the PE 500 may include fewer, more, or different components. The PE 500 is associated with a sparsity module 560. The sparsity module 560 may be an embodiment of the sparsity accelerator 460 in FIG. 4.

The input register file 510 stores at least part of an activation operand. The activation operand includes a sequence of input elements, aka activations. The activation operand may be a portion of an input tensor, e.g., an input tensor of a convolutional layer. The activation operand is associated with an activation bitmap 515. The activation bitmap 515 may be stored in the input register file 510, the local memory of the compute block that includes the PE 500, or both. The activation bitmap 515 can indicate positions of the non-zero-valued activations in the activation operand. The activation bitmap 515 includes a sequence of bits, each of which corresponds to a respective activation in the activation operand. In some embodiments, the position of a bit in the activation bitmap 515 matches the position of the corresponding activation in the activation operand. For the purpose of illustration, the activation bitmap 515 includes eight bits, and the activation operand includes eight activations. In other embodiments, the activation bitmap 515 may include fewer or more bits. As shown in FIG. 5, four of the eight bits in the activation bitmap 515 are zero valued, and the other four bits are one valued. A zero valued bit indicates that the value of the corresponding activation is zero, a one valued bit indicates that the value of the corresponding activation is non-zero. Accordingly, the activation operand includes four zero-valued activations and four non-zero-valued activations.

The weight register file 520 stores at least part of a weight operand. The weight operand includes a sequence of weights. The weight operand may be a portion of a filter, e.g., a filter of a convolutional layer. The weight operand is associated with a weight bitmap 525. The weight bitmap 525 may be stored in the weight register file 520, the local memory of the compute block that includes the PE 500, or both. The weight bitmap 525 can indicate positions of the non-zero-valued weights in the weight operand. The weight bitmap 525 includes a sequence of bits, each of which corresponds to a respective weight in the weight operand. In some embodiments, the position of a bit in the weight bitmap 525 matches the position of the corresponding weight in the weight operand. For the purpose of illustration, the weight bitmap 525 includes eight bits, and the weight operand includes eight weights. In other embodiments, the weight bitmap 525 may include fewer or more bits. As shown in FIG. 5, four of the eight bits in the weight bitmap 525 are zero valued, and the other four bits are one valued. A zero valued bit indicates that the value of the corresponding weight is zero, a one valued bit indicates that the value of the corresponding weight is non-zero. Accordingly, the weight operand includes four zero-valued weights and four non-zero-valued weights. The weight bitmap 525 can indicate positions of the non-zero-valued weights in the weight operand.

The sparsity module 560 generates a combined sparsity bitmap 535 based on the activation bitmap 515 and the weight bitmap 525. The sparsity module 560 may receive the activation bitmap 515 from the input register file 510 or the local memory of the compute block that includes the PE 500. The sparsity module 560 may receive the weight bitmap 525 from the weight register file 520 or the local memory of the compute block. In some embodiments, the sparsity module 560 is an AND operator. The sparsity module 560 may generate the combined sparsity bitmap 535 by performing one or more AND operations on the activation bitmap 515 and the weight bitmap 525. Each bit in the combined sparsity bitmap 535 is a result of an AND operation on a bit in the activation bitmap 515 and a bit in the weight bitmap 525. The position of the bit in the combined sparsity bitmap 535 matches the position of the bit in the activation bitmap 515 and the position of the bit in the weight bitmap 525. For instance, the first bit in the combined sparsity bitmap 535 is a result of an AND operation on the first bit in the activation bitmap 515 and the first bit in the weight bitmap 525, the second bit in the combined sparsity bitmap 535 is a result of an AND operation on the second bit in the activation bitmap 515 and the second bit in the weight bitmap 525, the third bit in the combined sparsity bitmap 535 is a result of an AND operation on the third bit in the activation bitmap 515 and the third bit in the weight bitmap 525, and so on.

A bit in the combined sparsity bitmap 535 has a value of one when the corresponding bit in the activation bitmap 515 and the corresponding bit in the weight bitmap 525 both have values of one. When at least one of the corresponding bits in the activation bitmap 515 and the corresponding bit in the weight bitmap 525 has a value of zero, the bit in the combined sparsity bitmap 535 has a value of zero. As shown in FIG. 5, the combined sparsity bitmap 535 includes six zeros and two ones.

The total number of ones in the combined sparsity bitmap 535 equals the total number of non-zero-valued activation-weight pairs that will be computed by the PE 500 to compute non-zero valued partial sums. The other activation-weight pairs are zero-valued activation-weight pairs and can be skipped for computation without any impact on the output accuracy, as these pairs will result in zero valued partial sums. Accordingly, the workload of the PE 500 in this compute round can be determined based on the total number of ones in the combined sparsity bitmap 535. The amount of time for the computation can also be estimated based on the total number of ones in the combined sparsity bitmap 535. The more ones in the combined sparsity bitmap 535, the higher the workload of the PE 500, and the longer the computation of the PE 500.

In some embodiments, the input register file 510 or the weight register file 520 stores dense data points, e.g., non-zero-valued activations or non-zero-valued weights. The sparse data points, e.g., zero-valued activations or zero-valued weights, are not stored in the input register file 510 or the weight register file 520. The dense data points may be compressed and kept adjacent to each other in the input register file 510 or the weight register file 520. The dense data point(s) of an activation operand is a compressed activation operand. The dense data point(s) of a weight operand constitutes a compressed weight operand. The position of the ones in the combined sparsity bitmap 535 cannot indicate the positions of the activations in the compressed activation operand or the positions of the weights in the compressed weight operand. The sparsity module 560 may perform sparsity computations to determine the positions of the activations in the compressed activation operand and the positions of the weights in the compressed weight operand. The sparsity module 560 may perform a round of sparsity computation for each of the two non-zero-valued activation-weight pairs. In each round of sparsity computation, the sparsity module 560 may compute an activation position bitmap and a weight position bitmap based on the activation bitmap 515, the weight bitmap 525, and the combined sparsity bitmap 535. The position of the activation in the compressed activation operand may be indicated by the number of ones in the activation position bitmap, and the position of the weight in the compressed weight operand may be indicated by the number of ones in the weight position bitmap. In the first round of sparsity computation, an intermediate bitmap may be determined and can be used in the second round to identify the next non-zero-valued activation-weight pair.

The sparsity module 560 can read, from the input register file 510 and the weight register file 520, the activations and weights of the non-zero-valued activation-weight pairs based on the positions determined through the sparsity computations and provides the activations and weights to the multiplier 530. The multiplier 530 performs multiplication operations on the activations and weights. For instance, the multiplier 530 performs a multiplication operation on the activation and weight in each non-zero-valued activation-weight individual pair and outputs a partial sum, i.e., a product of the activation and weight. As there are two activation-weight pairs, the multiplier 530 may perform two multiplication operations sequentially, e.g., based on the positions of the ones in the combined sparsity bitmaps 535. Without the sparsity acceleration, the multiplier 530 would need to perform eight multiplication operations. By reducing the number of multiplication operations from eight to two, the MAC operation in the PE 500 is accelerated. As a DNN accelerator usually performs a large number of MAC operations in the execution of a DNN, the sparsity acceleration can significantly improve the efficiency and performance of the DNN accelerator.

The accumulator 540 receives the two partial sums from the multiplier 530 and accumulates the two partial sums. The result of the accumulation is a PE-level internal partial sum. The PE-level internal partial sum may be stored in the output register file 550. In some embodiments, the accumulator 540 receives one or more PE-level internal partial sums from one or more other PEs. The accumulator 540 can accumulate the one or more PE-level internal partial sums with the PE-level internal partial sum of the PE 500 and store the result of the accumulation (i.e., a multi-PE internal partial sum) in the output register file 550. The one or more other PEs may be in the same column as the PE 500 in a PE array. The multi-PE internal partial sum may be a column-level internal partial sum. In some embodiments, the PE-level internal partial sum of the PE 500 or the multi-PE internal partial sum may be sent to one or more other PEs for further accumulation.

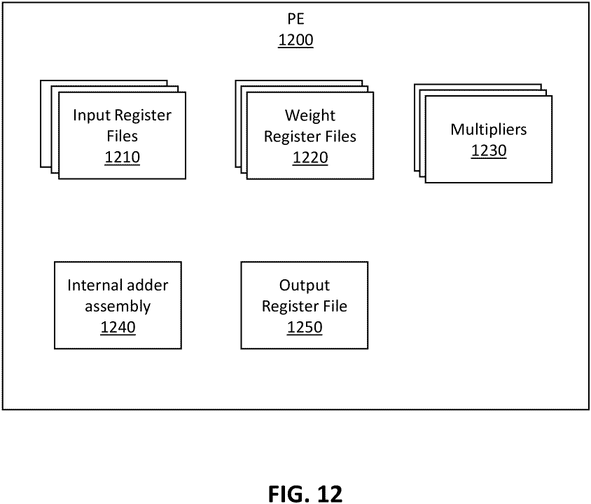

Even though FIG. 5 shows a single multiplier 530, the PE 500 may include multiple multipliers that can perform multiple multiplication operations at the same time. These multipliers can be coupled to an internal adder assembly, e.g., the internal adder assembly 1240 in FIG. 12.

### Example Sparsity-Based Reduction of Gate Switching in PE

FIG. 6 illustrates a PE 600 capable of reducing gate switching based on sparsity, in accordance with various embodiments. The PE 600 may be a PE in the PE array 440 in FIG. 4. As shown in FIG. 6, the PE 600 includes registers 610, 620, and 650, a multiplier 630, a MUX 640, and NOR gates 660, 670, and 680. In other embodiments, alternative configurations, different or additional components may be included in the PE 600. Further, functionality attributed to a component of the PE 600 may be accomplished by a different component included in the PE 600, another component included in the PE array, or a different device or system.

The register 610 may be a storage unit for storing activations to be processed by the multiplier 630. The register 610 may store an activation at a time. In some embodiments, the register 610 is associated with a clock and can be updated when a new clock cycle starts. For instance, an activation written into the register 610 in the current clock cycle may be replaced by another activation written into the register 610 in the next clock cycle.

The register 620 may be a storage unit for storing weights to be processed by the multiplier 630. The register 620 may store a weight at a time. In some embodiments, the register 620 is associated with a clock and can be updated when a new clock cycle starts. For instance, a weight written into the register 620 in the current clock cycle may be replaced by another weight written into the register 620 in the next clock cycle. The registers 610 and 620 may be referred to as input registers of the multiplier 630.

For a round of multiplication, the NOR gates 660, 670, and 680 may detect whether the activation or weight for this round is zero valued before the activation and weight are written into the registers 610 and 620, e.g., when the activation and weight in the previous round are still stored in the registers 610 and 620. The NOR gate 660 receives the activation from the register 610 as an input, and the NOR gate 670 receives the weight from the register 620 as an input. A non-zero valued input will result in a ‘0’ output signal of the NOR gate 660 or 670. A zero valued input will result in a ‘1’ output signal of the NOR gate 660 or 670.

The NOR gate 680 receives the outputs of the NOR gates 660 and 670 as inputs. In cases where either input is ‘1,’ the NOR gate 680 outputs a ‘0’ output signal. The ‘0’ output signal of the NOR gate 680 may be a control signal that can prevent the writing of the activation and weight for this round into the registers 610 and 620. The control signal may also activate or deactivate the multiplier 630. In some embodiments, the registers 610 and 620 are not updated in this round given the 0′ output signal of the NOR gate 680. The activation and weight for the previous round, the product of which has been computed by the multiplier 630 in the previous round, may stay in the registers 610 and 620. This way, gate switching can be reduced or avoided. In some embodiments, the multiplier 630 may compute the product of the activation and weight for the previous round in this round.

Even though the NOR gates 660, 670, and 680 are used to detect zero-valued activation or weight in the embodiments of FIG. 6, different, fewer, or more logic gates may be used in other embodiments. For instance, one or more OR gates, AND gates, or other types of logic gates may be used in addition or alternative to the NOR gates 660, 670, and 680. Also, the embodiments of FIG. 6 use the activation or weight itself for the zero detection, but different data may be used to detect zero-valued activation or weight in other embodiments. For example, a bit in the activation bitmap of the activation operand may be used to determine whether the activation is zero valued. Similarly, a bit in the weight bitmap of the weight operand may be used to determine whether the weight is zero valued. As another example, a bit in the combined sparsity bitmap may be used to determine whether the activation or weight is zero valued.

The MUX 640 receives the output of the multiplier 630 (i.e., the product of the activation and weight for the previous round). The MUX 640 also receives the output signal of the NOR gate 680. The MUX 640 may generate a ‘0’ output signal, which is written into the register 650. The register 650 is an output register of the multiplier. In this way, the output of the multiplier 630 is zeroed by using the MUX 640 even though the multiplier 630 does not process the activation and weight for this round. In other embodiments, an AND gate may be used in lieu of the MUX 640.

In cases where the activation and weight for this round are both non-zero valued, the outputs of the NOR gates 660 and 670 are ‘0,’ and the NOR gate 680 outputs a ‘1’ output signal. The registers 610 and 620 will be updated so that the activation and weight for the previous round will be replaced by the activation and weight for this round. The multiplier 630 will compute a product of the activation and weight for this round, and the product will be received by the MUX 640. The MUX 640 also receives the ‘1’ output signal of the NOR gate 680. The MUX 640 outputs the product, which is written into the register 650.

FIG. 7 illustrates a PE 700 with a pipelined multiplier 730, in accordance with various embodiments. The PE 700 may be a PE in the PE array 440 in FIG. 4. As shown in FIG. 7, the PE 700 also includes registers 710, 720, 750, 790, and 795, a MUX 740, and NOR gates 760, 770, and 780. In other embodiments, alternative configurations, different or additional components may be included in the PE 700. Further, functionality attributed to a component of the PE 700 may be accomplished by a different component included in the PE 700, another component included in the PE array, or a different device or system.

The register 710 may be a storage unit for storing activations to be processed by the multiplier 730. The register 710 may store an activation at a time. In some embodiments, the register 710 is associated with a clock and can be updated when a new clock cycle starts. For instance, an activation written into the register 710 in the current clock cycle may be replaced by another activation written into the register 710 in the next clock cycle.

The register 720 may be a storage unit for storing weights to be processed by the multiplier 730. The register 720 may store a weight at a time. In some embodiments, the register 720 is associated with a clock and can be updated when a new clock cycle starts. For instance, a weight written into the register 720 in the current clock cycle may be replaced by another weight written into the register 720 in the next clock cycle. The registers 710 and 720 may be referred to as input registers of the multiplier 730.

For a round of multiplication, the NOR gates 760, 770, and 780 may detect whether the activation or weight for this round is zero valued before the activation and weight are written into the registers 710 and 720, e.g., when the activation and weight in the previous round are still stored in the registers 710 and 720. The NOR gate 760 receives the activation from the register 710 as an input, and the NOR gate 770 receives the weight from the register 720 as an input. A non-zero valued input will result in a ‘0’ output signal of the NOR gate 760 or 770. A zero valued input will result in a ‘1’ output signal of the NOR gate 760 or 770.

The NOR gate 780 receives the outputs of the NOR gates 760 and 770 as inputs. In cases where either input is ‘1,’ the NOR gate 780 outputs a ‘0’ output signal. The ‘0’ output signal of the NOR gate 780 may be a control signal that can prevent the writing of the activation and weight for this round into the registers 710 and 720. The control signal may also activate or deactivate the multiplier 730. In some embodiments, the registers 710 and 720 are not updated in this round given the 0′ output signal of the NOR gate 780. The activation and weight for the previous round, the product of which has been computed by the multiplier 730 in the previous round, may stay in the registers 710 and 720. This way, gate switching can be reduced or avoided.

Even though the NOR gates 760, 770, and 780 are used to detect zero-valued activation or weight in the embodiments of FIG. 7, different, fewer, or more logic gates may be used in other embodiments. For instance, one or more OR gates, AND gates, or other types of logic gates may be used in addition or alternative to the NOR gates 760, 770, and 780. Also, the embodiments of FIG. 7 use the activation or weight itself for the zero detection, but different data may be used to detect zero-valued activation or weight in other embodiments. For example, a bit in the activation bitmap of the activation operand may be used to determine whether the activation is zero valued. Similarly, a bit in the weight bitmap of the weight operand may be used to determine whether the weight is zero valued. As another example, a bit in the combined sparsity bitmap may be used to determine whether the activation or weight is zero valued.

The multiplier 730 is pipelined. For the purpose of simplicity and illustration, the multiplier 730 has two pipes, represented by the rectangles inside the multiplier 730 in FIG. 7. The two pipes are associated with the two registers 790 and 795, respectively. The register 790 and 795 may delay the zeroing signals from the NOR gate 780 (or from the NOR gates 760, 770, and 780). The zeroing signal from the NOR gate 780 may be delayed by two pipes. After the pipeline in the multiplier 730 is completed, the MUX 740 may receive the ‘0’ output signal of the NOR gate 780 and outputs a zero, which is written into the register 750. The register 750 is an output register of the multiplier. In this way, the output of the multiplier 730 is zeroed by using the MUX 740 even though the multiplier 730 does not process the activation and weight for this round. In other embodiments, an AND gate may be used in lieu of the MUX 740.

In cases where the activation and weight for this round are both non-zero valued, the outputs of the NOR gates 760 and 770 are ‘0,’ and the NOR gate 780 outputs a ‘1’ output signal. The registers 710 and 720 will be updated so that the activation and weight for the previous round will be replaced by the activation and weight for this round. The multiplier 730 will compute a product of the activation and weight for this round, and the product will be received by the MUX 740. The MUX 740 also receives the ‘1’ output signal of the NOR gate 780. The MUX 740 outputs the product, which is written into the register 750.

FIG. 8 illustrates a PE with a multiplier 830 and an accumulator 845, in accordance with various embodiments. Gate switching and power consumption in the PE 800 can be reduced by zeroing the input of the accumulator 845 in situations where the activation or weight in an activation-weight pair is zero. The PE 800 may be a PE in the PE array 440 in FIG. 4. As shown in FIG. 8, the PE 800 also includes registers 810, 820, 850, 890, and 895, an AND gate 840, and NOR gates 860, 870, and 880. In other embodiments, alternative configurations, different or additional components may be included in the PE 800. Further, functionality attributed to a component of the PE 800 may be accomplished by a different component included in the PE 800, another component included in the PE array, or a different device or system.

The register 810 may be a storage unit for storing activations to be processed by the multiplier 830. The register 810 may store an activation at a time. In some embodiments, the register 810 is associated with a clock and can be updated when a new clock cycle starts. For instance, an activation written into the register 810 in the current clock cycle may be replaced by another activation written into the register 810 in the next clock cycle.

The register 820 may be a storage unit for storing weights to be processed by the multiplier 830. The register 820 may store a weight at a time. In some embodiments, the register 820 is associated with a clock and can be updated when a new clock cycle starts. For instance, a weight written into the register 820 in the current clock cycle may be replaced by another weight written into the register 820 in the next clock cycle. The registers 810 and 820 may be referred to as input registers of the multiplier 830.

For a round of multiplication, the NOR gates 860, 870, and 880 may detect whether the activation or weight for this round is zero valued before the activation and weight are written into the registers 810 and 820, e.g., when the activation and weight in the previous round are still stored in the registers 810 and 820. The NOR gate 860 receives the activation from the register 810 as an input, and the NOR gate 870 receives the weight from the register 820 as an input. A non-zero valued input will result in a ‘0’ output signal of the NOR gate 860 or 870. A zero valued input will result in a ‘1’ output signal of the NOR gate 860 or 870.

The NOR gate 880 receives the outputs of the NOR gates 860 and 870 as inputs. In cases where either input is ‘1,’ the NOR gate 880 outputs a ‘0’ output signal. The ‘0’ output signal of the NOR gate 880 may be a control signal that can prevent the writing of the activation and weight for this round into the registers 810 and 820. The control signal may be used to control input to the accumulator 845. In some embodiments, the registers 810 and 820 are not updated in this round given the 0′ output signal of the NOR gate 880. The activation and weight for the previous round, the product of which has been computed by the multiplier 830 in the previous round, may stay in the registers 810 and 820. This way, gate switching can be reduced or avoided. The output signal of the NOR gate 880 may be stored in the register 890, e.g., for synchronization purpose.

Even though the NOR gates 860, 870, and 880 are used to detect zero-valued activation or weight in the embodiments of FIG. 8, different, fewer, or more logic gates may be used in other embodiments. For instance, one or more OR gates, AND gates, or other types of logic gates may be used in addition or alternative to the NOR gates 860, 870, and 880. Also, the embodiments of FIG. 8 use the activation or weight itself for the zero detection, but different data may be used to detect zero-valued activation or weight in other embodiments. For example, a bit in the activation bitmap of the activation operand may be used to determine whether the activation is zero valued. Similarly, a bit in the weight bitmap of the weight operand may be used to determine whether the weight is zero valued. As another example, a bit in the combined sparsity bitmap may be used to determine whether the activation or weight is zero valued.

The multiplier 830 may compute a product of the activation and weight for the previous round again, which requires less gate switching compared with computing a product of the activation and weight for the current round. The output of the multiplier 830 may be stored in the register 850, e.g., for synchronization purposes.

The AND gate 840 receives the data in the registers 850 and 890 as inputs. The AND gate 840 performs an AND operation on the inputs. In cases where the control signal from the NOR gate 880 is a “0” signal, the AND gate 840 outputs a “0” signal. The control signal can zero the output of the multiplier 830 through the AND operation by the AND gate 840. The accumulator 845 receives the zero signal from the AND gate 840 as an input. In this way, the input of accumulator 845 is zeroed by using the AND gate 840 even though the multiplier 830 does not process the activation and weight for this round. The accumulator 845 may accumulate the input with one or more signals from the AND gate 840 in other rounds. The sum computed by the accumulator 845 may be a partial sum in the MAC operation.

In cases where the activation and weight for this round are both non-zero valued, the outputs of the NOR gates 860 and 870 are ‘0,’ and the NOR gate 880 outputs a ‘1’ output signal, which will be stored in the register 890. The registers 810 and 820 will be updated so that the activation and weight for the previous round will be replaced by the activation and weight for this round. The multiplier 830 will compute a product of the activation and weight for this round, and the product will be stored in the register 850. The AND gate 840 receives data from the registers 850 and 890 and outputs a result of an AND operation on the “1” output signal from the NOR gate 880 and the product computed by the multiplier 830 as the output. The result would equal the product computed by the multiplier 830. The accumulator 845 will then receive the product computed by the multiplier 830 and may accumulate the product computed by the multiplier 830 with one or more signals from the AND gate 840 in other rounds.

FIG. 9 illustrates a PE with an accumulator 945 having a register 995 that is configurable based on sparsity, in accordance with various embodiments. Gate switching and power consumption in the PE 900 can be reduced by disabling the accumulator 945 in situations where the activation or weight in an activation-weight pair is zero. The PE 900 may be a PE in the PE array 440 in FIG. 4. As shown in FIG. 9, the PE 900 also includes registers 910, 920, 950, 990, and 995, and NOR gates 960, 970, and 980. In other embodiments, alternative configurations, different or additional components may be included in the PE 900. Further, functionality attributed to a component of the PE 900 may be accomplished by a different component included in the PE 900, another component included in the PE array, or a different device or system.

The register 910 may be a storage unit for storing activations to be processed by the multiplier 930. The register 910 may store an activation at a time. In some embodiments, the register 910 is associated with a clock and can be updated when a new clock cycle starts. For instance, an activation written into the register 910 in the current clock cycle may be replaced by another activation written into the register 910 in the next clock cycle.

The register 920 may be a storage unit for storing weights to be processed by the multiplier 930. The register 920 may store a weight at a time. In some embodiments, the register 920 is associated with a clock and can be updated when a new clock cycle starts. For instance, a weight written into the register 920 in the current clock cycle may be replaced by another weight written into the register 920 in the next clock cycle. The registers 910 and 920 may be referred to as input registers of the multiplier 930.

For a round of multiplication, the NOR gates 960, 970, and 980 may detect whether the activation or weight for this round is zero valued before the activation and weight are written into the registers 910 and 920, e.g., when the activation and weight in the previous round are still stored in the registers 910 and 920. The NOR gate 960 receives the activation from the register 910 as an input, and the NOR gate 970 receives the weight from the register 920 as an input. A non-zero valued input will result in a ‘0’ output signal of the NOR gate 960 or 970. A zero valued input will result in a ‘1’ output signal of the NOR gate 960 or 970.

The NOR gate 980 receives the outputs of the NOR gates 960 and 970 as inputs. In cases where either input is ‘1,’ the NOR gate 980 outputs a ‘0’ output signal. The ‘0’ output signal of the NOR gate 980 can prevent the writing of the activation and weight for this round into the registers 910 and 920. In some embodiments, the registers 910 and 920 are not updated in this round given the 0′ output signal of the NOR gate 980. The activation and weight for the previous round, the product of which has been computed by the multiplier 930 in the previous round, may stay in the registers 910 and 920. This way, gate switching can be reduced or avoided. The output signal of the NOR gate 980 may be stored in the register 990, e.g., as a control signal that may control the register 995.

Even though the NOR gates 960, 970, and 980 are used to detect zero-valued activation or weight in the embodiments of FIG. 9, different, fewer, or more logic gates may be used in other embodiments. For instance, one or more OR gates, AND gates, or other types of logic gates may be used in addition or alternative to the NOR gates 960, 970, and 980. Also, the embodiments of FIG. 9 use the activation or weight itself for the zero detection, but different data may be used to detect zero-valued activation or weight in other embodiments. For example, a bit in the activation bitmap of the activation operand may be used to determine whether the activation is zero valued. Similarly, a bit in the weight bitmap of the weight operand may be used to determine whether the weight is zero valued. As another example, a bit in the combined sparsity bitmap may be used to determine whether the activation or weight is zero valued.

The multiplier 930 may compute a product of the activation and weight for the previous round again, which requires less gate switching compared with computing a product of the activation and weight for the current round. The output of the multiplier 930 may be stored in the register 950.

The ‘0’ signal stored in the register 990 can prevent the register 995 from being updated, i.e., the accumulator 945 is disable for this round and the accumulator 945 may not perform any accumulation in this round, which can reduce gate switching in this round. The signal in the register 990 may be a control signal that can be a clock enable signal or clock disable signal for the register 995. The register 995 is configured to store the output of the accumulator 945. In some embodiments (such as embodiments where the multiplier 830 is pipelined), the disabling signal can be delayed, e.g., by the number of pipes in the multiplier 830. The delay can be facilitated by the register 990. For instance, the disabling signal can be kept at the register 990 during the delay.

In cases where the activation and weight for this round are both non-zero valued, the outputs of the NOR gates 960 and 970 are ‘0,’ and the NOR gate 980 outputs a ‘1’ output signal, which will be stored in the register 990. The registers 910 and 920 will be updated so that the activation and weight for the previous round will be replaced by the activation and weight for this round. The multiplier 930 will compute a product of the activation and weight for this round, and the product will be stored in the register 950. As the register 990 stores the a ‘1’ output signal, which is not a disabling signal. The accumulator 945 will then receive the product computed by the multiplier 930 and may accumulate the product computed by the multiplier 930 with one or more signals from the MUX 940 in other rounds.

FIG. 10 illustrates a PE 1000 with an adder tree, in accordance with various embodiments. The PE 1000 may be a PE in the PE array 440 in FIG. 4. In addition to the adder tree, the PE 1000 includes multiplication assemblies 1005A-1005D (collectively referred to as “multiplication assemblies 1005” or “multiplication assembly 1005”). In other embodiments, alternative configurations, different or additional components may be included in the PE 1000. For instance, the PE 1000 may include a different number of multiplication assemblies 1005. Different multiplication assemblies 1005 may have different components or configurations. Further, functionality attributed to a component of the PE 1000 may be accomplished by a different component included in the PE 1000, another component included in the PE array, or a different device or system.

The multiplication assemblies 1005 computes products of activation-weight pairs. The multiplication assemblies 1005 transmits the products to the adder tree for accumulating the products. The adder tree includes three accumulators 1070, 1080, and 1090. The adder tree has two tiers: with the accumulators 1070 and 1080 in the first tier and the accumulator 1090 in the second tier. In other embodiments, the adder tree may include a different number of accumulators or have a different tier structure.

A multiplication assembly 1005 includes registers 1010, 1020, and 1050, a multiplier 1030, an AND gate 1040, and a zero detector 1060. The multiplication assembly can detect zero-valued activations or weights to accelerate computation in the PE 1000 and reduce power consumed by the PE 1000 for the computation. The register 1010 may be a storage unit for storing activations to be processed by the multiplier 1030. The register 1010 may store an activation at a time. In some embodiments, the register 1010 is associated with a clock and can be updated when a new clock cycle starts. For instance, an activation written into the register 1010 in the current clock cycle may be replaced by another activation written into the register 1010 in the next clock cycle.

The register 1020 may be a storage unit for storing weights to be processed by the multiplier 1030. The register 1020 may store a weight at a time. In some embodiments, the register 1020 is associated with a clock and can be updated when a new clock cycle starts. For instance, a weight written into the register 1020 in the current clock cycle may be replaced by another weight written into the register 1020 in the next clock cycle. The registers 1010 and 1020 may be referred to as input registers of the multiplier 1030.

The zero detector 1060 detects whether the activation or weight for a round of multiplication is zero valued. In some embodiments, the zero detector 1060 includes one or more logical operators, such as NOR gates like the NOR gates 660, 670, and 680 in FIG. 6. The zero detector 1060 may output a signal indicating whether the activation or weight is zero valued. For instance, the zero detector may output a ‘0’ output signal in embodiments where the activation or weight is zero valued versus a ‘1’ output signal in embodiments where neither the activation nor the weight is zero valued.

The AND gate 1040 receives the output of the multiplier 1030 and the output of the zero detector 1060. The AND gate 1040 may output a ‘0’ signal in embodiments where the activation or weight is zero valued versus. In embodiments where neither the activation nor the weight is zero valued, the AND gate 1040 may output the product computed by the multiplier 1030. The output of the AND gate 1040 may be written into the register 1050. The register 1050 is an output register of the multiplication assembly 1005.

The data in the register 1050 is transmitted to the accumulator 1070 or 1080 that is coupled with the multiplication assembly 1005. The accumulator 1070 may accumulate outputs of the multiplication assemblies 1005A and 1005B. The accumulator 1080 may accumulate outputs of the multiplication assemblies 1005C and 1005D. The outputs of the accumulators 1070 and 1080 are provided to the accumulator 1090,which accumulates the outputs from the first tier and generates an output of the PE 1000. In some embodiments, the accumulator 1090 may be associated with a register (not shown in FIG. 10) where the output of the accumulator 1090 may be stored. The accumulator 1090 may accumulate its own output with one or more outputs from one or more other PEs 1000. In some embodiments, gate switching in the accumulator 1070, 1080, or 1090 may be reduced using the mechanism described above in conjunction with FIGS. 8 and 9.

### Example PE Array

FIG. 11 illustrates a PE array 1100, in accordance with various embodiments. The PE array 1100 may be an embodiment of the PE array 440 in FIG. 4. The PE array 1100 includes a plurality of PEs 1110 (individually referred to as “PE 1110”). The PEs 1110 perform MAC operations. The PEs 1110 may also be referred to as neurons in the DNN. Each PE 1110 has two input signals 1150 and 1160 and an output signal 1170. The input signal 1150 is at least a portion of an IFM to the layer. The input signal 1160 is at least a portion of a filter of the layer. In some embodiments, the input signal 1150 of a PE 1110 includes one or more activation operands, and the input signal 1160 includes one or more weight operands.

Each PE 1110 performs an MAC operation on the input signals 1150 and 1160 and outputs the output signal 1170, which is a result of the MAC operation. Some or all of the input signals 1150 and 1160 and the output signal 1170 may be in an integer format, such as INT8, or floating-point format, such as FP16 or BF16. For purpose of simplicity and illustration, the input signals and output signal of all the PEs 1110 have the same reference numbers, but the PEs 1110 may receive different input signals and output different output signals from each other. Also, a PE 1110 may be different from another PE 1110, e.g., including more, fewer, or different components.

As shown in FIG. 11, the PEs 1110 are connected to each other, as indicated by the dash arrows in FIG. 11. The output signal 1170 of an PE 1110 may be sent to many other PEs 1110 (and possibly back to itself) as input signals via the interconnections between PEs 1110. In some embodiments, the output signal 1170 of an PE 1110 may incorporate the output signals of one or more other PEs 1110 through an accumulate operation of the PE 1110 and generates an internal partial sum of the PE array. More details about the PEs 1110 are described below in conjunction with FIG. 11B.

In the embodiments of FIG. 11, the PEs 1110 are arranged into columns 1105 (individually referred to as “column 1105”). The input and weights of the layer may be distributed to the PEs 1110 based on the columns 1105. Each column 1105 has a column buffer 1120. The column buffer 1120 stores data provided to the PEs 1110 in the column 1105 for a short amount of time. The column buffer 1120 may also store data output by the last PE 1110 in the column 1105. The output of the last PE 1110 may be a sum of the MAC operations of all the PEs 1110 in the column 1105, which is a column-level internal partial sum of the PE array 1100. In other embodiments, input and weights may be distributed to the PEs 1110 based on rows in the PE array 1100. The PE array 1100 may include row buffers in lieu of column buffers 1120. A row buffer may store input signals of the PEs in the corresponding row and may also store a row-level internal partial sum of the PE array 1100.

As shown in FIG. 11, each column buffer 1120 is associated with a load 1130 and a drain 1140. The data provided to the column 1105 is transmitted to the column buffer 1120 through the load 1130, e.g., through upper memory hierarchies, e.g., the local memory 410 in FIG. 4. The data generated by the column 1105 is extracted from the column buffers 1120 through the drain 1140. In some embodiments, data extracted from a column buffer 1120 is sent to upper memory hierarchies, e.g., the local memory 410 in FIG. 4, through the drain operation. In some embodiments, the drain operation does not start until all the PEs 1110 in the column 1105 has finished their MAC operations. Even though not shown in FIG. 11, one or more columns 1105 may be associated with an external adder assembly.

FIG. 12 is a block diagram of a PE 1200, in accordance with various embodiments. The PE 1200 may be an embodiment of the PE 1110 in FIG. 11. The PE 1200 includes input register files 1210 (individually referred to as “input register file 1210”), weight registers file 1220 (individually referred to as “weight register file 1220”), multipliers 1230 (individually referred to as “multiplier 1230”), an internal adder assembly 1240, and an output register file 1250. In other embodiments, the PE 1200 may include fewer, more, or different components. For example, the PE 1200 may include multiple output register files 1250. As another example, the PE 1200 may include a single input register file 1210, weight register file 1220, or multiplier 1230. As yet another example, the PE 1200 may include an adder in lieu of the internal adder assembly 1240.

The input register files 1210 temporarily store activation operands for MAC operations by the PE 1200. In some embodiments, an input register file 1210 may store a single activation operand at a time. In other embodiments, an input register file 1210 may store multiple activation operand or a portion of an activation operand at a time. An activation operand includes a plurality of input elements (i.e., input elements) in an input tensor. The input elements of an activation operand may be stored sequentially in the input register file 1210 so the input elements can be processed sequentially. In some embodiments, each input element in the activation operand may be from a different input channel of the input tensor. The activation operand may include an input element from each of the input channels of the input tensor, and the number of input elements in an activation operand may equal the number of the input channels. The input elements in an activation operand may have the same XY coordinates, which may be used as the XY coordinates of the activation operand. For instance, all the input elements of an activation operand may be X0Y0, X0Y1, X1Y1, etc.

The weight register file 1220 temporarily stores weight operands for MAC operations by the PE 1200. The weight operands include weights in the filters of the DNN layer. In some embodiments, the weight register file 1220 may store a single weight operand at a time. other embodiments, an input register file 1210 may store multiple weight operands or a portion of a weight operand at a time. A weight operand may include a plurality of weights. The weights of a weight operand may be stored sequentially in the weight register file 1220 so the weight can be processed sequentially. In some embodiments, for a multiplication operation that involves a weight operand and an activation operand, each weight in the weight operand may correspond to an input element of the activation operand. The number of weights in the weight operand may equal the number of the input elements in the activation operand.

In some embodiments, a weight register file 1220 may be the same or similar as an input register file 1210, e.g., having the same size, etc. The PE 1200 may include a plurality of register files, some of which are designated as the input register files 1210 for storing activation operands, some of which are designated as the weight register files 1220 for storing weight operands, and some of which are designated as the output register file 1250 for storing output operands. In other embodiments, register files in the PE 1200 may be designated for other purposes, e.g., for storing scale operands used in elementwise add operations, etc.

The multipliers 1230 perform multiplication operations on activation operands and weight operands. A multiplier 1230 may perform a sequence of multiplication operations on a single activation operand and a single weight operand and generates a product operand including a sequence of products. Each multiplication operation in the sequence includes multiplying an input element in the activation operand and a weight in the weight operand. In some embodiments, a position (or index) of the input element in the activation operand matches the position (or index) of the weight in the weight operand. For instance, the first multiplication operation is a multiplication of the first input element in the activation operand and the first weight in the weight operand, the second multiplication operation is a multiplication of the second input element in the activation operand and the second weight in the weight operand, the third multiplication operation is a multiplication of the third input element in the activation operand and the third weight in the weight operand, and so on. The input element and weight in the same multiplication operation may correspond to the same depthwise channel, and their product may also correspond to the same depthwise channel.

Multiple multipliers 1230 may perform multiplication operations simultaneously. These multiplication operations may be referred to as a round of multiplication operations. In a round of multiplication operations by the multipliers 1230, each of the multipliers 1230 may use a different activation operand and a different weight operand. The different activation operands or weight operands may be stored in different register files of the PE 1200. For instance, a first multiplier 1230 uses a first activation operand (e.g., stored in a first input register file 1210) and a first weight operand (e.g., stored in a first weight register file 1220), versus a second multiplier 1230 uses a second activation operand (e.g., stored in a second input register file 1210) and a second weight operand (e.g., stored in a second weight register file 1220), a third multiplier 1230 uses a third activation operand (e.g., stored in a third input register file 1210) and a third weight operand (e.g., stored in a third weight register file 1220), and so on. For an individual multiplier 1230, the round of multiplication operations may include a plurality of cycles. A cycle includes a multiplication operation on an input element and a weight.

The multipliers 1230 may perform multiple rounds of multiplication operations. A multiplier 1230 may use the same weight operand but different activation operands in different rounds. For instance, the multiplier 1230 performs a sequence of multiplication operations on a first activation operand stored in a first input register file in a first round, versus a second activation operand stored in a second input register file in a second round. In the second round, a different multiplier 1230 may use the first activation operand and a different weight operand to perform another sequence of multiplication operations. That way, the first activation operand is reused in the second round. The first activation operand may be further reused in additional rounds, e.g., by additional multipliers 1230.

The internal adder assembly 1240 includes one or more adders inside the PE 1200, i.e., internal adders. The internal adder assembly 1240 may perform accumulation operations on two or more products operands from multipliers 1230 and produce an output operand of the PE 1200. In some embodiments, the internal adders are arranged in a sequence of tiers. A tier includes one or more internal adders. For the first tier of the internal adder assembly 1240, an internal adder may receive product operands from two or more multipliers 1230 and generate a sum operand through a sequence of accumulation operations. Each accumulation operation produces a sum of two or more products, each of which is from a different multiplier 1230. The sum operand includes a sequence of sums, each of which is a result of an accumulation operation and corresponds to a depthwise channel. For the other tier(s) of the internal adder assembly 1240, an internal adder in a tier receives sum operands from the precedent tier in the sequence. Each of these number may be generated by a different internal adder in the precedent tier. A ratio of the number of internal adders in a tier to the number of internal adders in a subsequent tier may be 2:1. In some embodiments, the last tier of the internal adder assembly 1240 may include a single internal adder, which produces the output operand of the PE 1200.

The output register file 1250 stores output operands of the PE 1200. In some embodiments, the output register file 1250 may store an output operand at a time. In other embodiments, the output register file 1250 may store multiple output operand or a portion of an output operand at a time. An output operand includes a plurality of output elements in an IFM. The output elements of an output operand may be stored sequentially in the output register file 1250 so the output elements can be processed sequentially. In some embodiments, each output element in the output operand corresponds to a different depthwise channel and is an element of a different output channel of the output channel of the depthwise convolution. The number of output elements in an output operand may equal the number of the depthwise channels of the depthwise convolution.

### Example Method of Reducing Power Consumption for DNNs

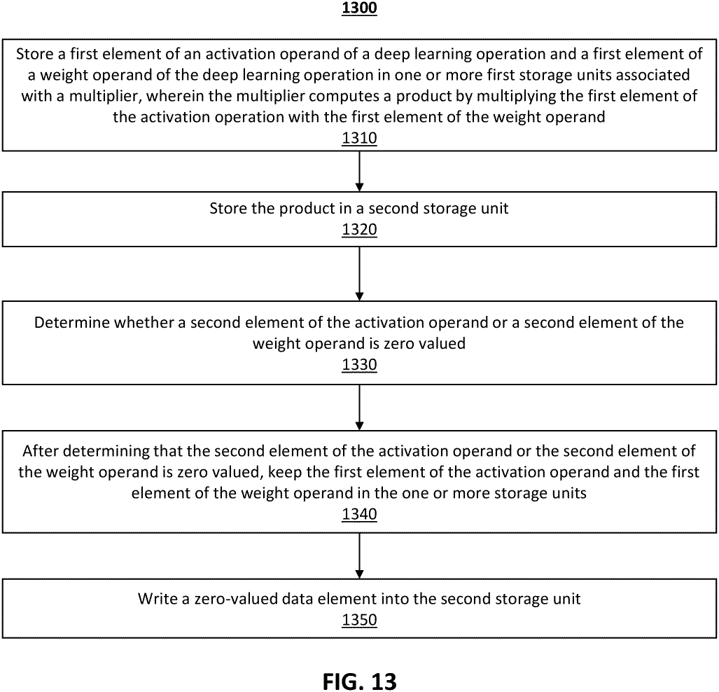

FIG. 13 is a flowchart showing a method 1300 of reducing power consumption for DNNs based on sparsity, in accordance with various embodiments. The method 1300 may be performed by the sparsity module 450 in FIG. 4. Although the method 1300 is described with reference to the flowchart illustrated in FIG. 13, many other methods for reducing power consumption for DNNs based on sparsity may alternatively be used. For example, the order of execution of the steps in FIG. 13 may be changed. As another example, some of the steps may be changed, eliminated, or combined.

The sparsity module 450 stores 1310 a first element of an activation operand of a deep learning operation and a first element of a weight operand of the deep learning operation in one or more first storage units associated with a multiplier. The multiplier computes a product by multiplying the first element of the activation operation with the first element of the weight operand.

The sparsity module 450 stores 1320 the product in a second storage unit. In some embodiments, the second storage unit is associated with the multiplier for storing outputs of the multiplier. The second storage unit may store an output of the multiplier at a time. In other embodiments, the second storage unit is associated with an accumulator. The accumulator is configured to accumulate products computed by the multiplier or one or more other multipliers. The second storage unit may store inputs to the accumulator. The second storage unit may store an input to the accumulator at a time.

The sparsity module 450 determines 1330 whether a second element of the activation operand or a second element of the weight operand is zero valued. In some embodiments, the sparsity module 450 performs a logical operation on the second element of the activation operand or the second element of the weight operand to determine whether the second element of the activation operand or the second element of the weight operand is zero valued. In other embodiments, the sparsity module 450 determines whether a value of the second element of the activation operand or the second element of the weight operand is no greater than a threshold to determine whether the second element of the activation operand or the second element of the weight operand is zero valued.

In other embodiments, the sparsity module 450 determines whether the second element of the activation operand or the second element of the weight operand is zero valued based on an activation bitmap or a weight bitmap. The activation bitmap comprises a sequence of bits, each of which corresponds to a respective element of the activation operand and indicates whether the respective element of the activation operand is zero valued. The weight bitmap comprises a sequence of bits, each of which corresponds to a respective element of the weight operand and indicates whether the respective element of the weight operand is zero valued.

In some embodiments, the sparsity module 450 performs a logical operation on a bit in the activation bitmap and a bit in the weight bitmap. The bit in the activation bitmap corresponds to the second element of the activation operand. The bit in the weight bitmap corresponds to the second element of the weight operand.

In some embodiments, the sparsity module 450 computes a combined bitmap based on the activation bitmap and the weight bitmap. The combined bitmap comprises a sequence of bits, each of which is a product of a bit in the activation bitmap and a bit in the weight bitmap. The sparsity module 450 determines whether the second element of the activation operand or the second element of the weight operand is zero valued based on the combined bitmap.

The sparsity module 450 keeps 1340 the first element of the activation operand and the first element of the weight operand in the one or more first storage units, after determining that the second element of the activation operand or the second element of the weight operand is zero valued.

The sparsity module 450 writes 1350 a zero-valued data element into the second storage unit. In some embodiments, the sparsity module 450 writes the zero-valued data element into the second storage unit after a pipeline in the multiplier is completed. In some embodiments, the sparsity module 450 transmits the product and the zero-valued data element to an accumulator. In other embodiments, the sparsity module 450 transmits the product to an accumulator. After determining that the second element of the activation operand or the second element of the weight operand is zero valued, the sparsity module 450 disables the accumulator.

In some embodiments, the first element of the activation operand is arranged before the second element of the activation operand. The multiplier computes the product in a first clock cycle. The zero-valued data element is written into the second storage unit in a second clock cycle after the first clock cycle. The first element of the activation operand and the first element of the weight operand are stored in the one or more first storage units in the first clock cycle and the second clock cycle.

### Example Computing Device

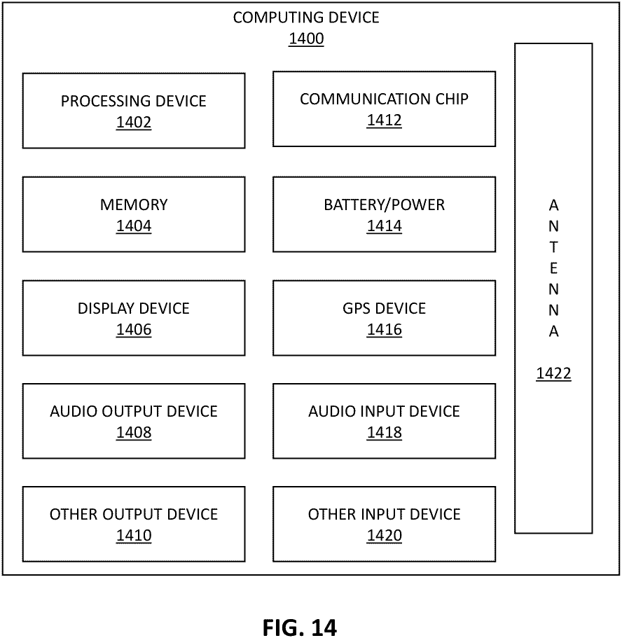

FIG. 14 is a block diagram of an example computing device 1400, in accordance with various embodiments. In some embodiments, the computing device 1400 may be used as at least part of the DNN accelerator 300 in FIG. 3. A number of components are illustrated in FIG. 14 as included in the computing device 1400, but any one or more of these components may be omitted or duplicated, as suitable for the application. In some embodiments, some or all of the components included in the computing device 1400 may be attached to one or more motherboards. In some embodiments, some or all of these components are fabricated onto a single system on a chip (SoC) die. Additionally, in various embodiments, the computing device 1400 may not include one or more of the components illustrated in FIG. 14, but the computing device 1400 may include interface circuitry for coupling to the one or more components. For example, the computing device 1400 may not include a display device 1406, but may include display device interface circuitry (e.g., a connector and driver circuitry) to which a display device 1406 may be coupled. In another set of examples, the computing device 1400 may not include an audio input device 1418 or an audio output device 1408 but may include audio input or output device interface circuitry (e.g., connectors and supporting circuitry) to which an audio input device 1418 or audio output device 1408 may be coupled.

The computing device 1400 may include a processing device 1402 (e.g., one or more processing devices). The processing device 1402 processes electronic data from registers and/or memory to transform that electronic data into other electronic data that may be stored in registers and/or memory. The computing device 1400 may include a memory 1404, which may itself include one or more memory devices such as volatile memory (e.g., DRAM), nonvolatile memory (e.g., read-only memory (ROM)), high bandwidth memory (HBM), flash memory, solid state memory, and/or a hard drive. In some embodiments, the memory 1404 may include memory that shares a die with the processing device 1402. In some embodiments, the memory 1404 includes one or more non-transitory computer-readable media storing instructions executable to perform operations, e.g., the method 1300 described above in conjunction with FIG. 13 or some operations performed by the compute block 400 (e.g., the sparsity module 450 in the compute block 400) described above in conjunction with FIG. 4 or a PE (e.g., the PE 500, PE 600, PE 700, PE 800, PE 900, PE 1000, PE 1110, etc.). The instructions stored in the one or more non-transitory computer-readable media may be executed by the processing device 1402.

In some embodiments, the computing device 1400 may include a communication chip 1412 (e.g., one or more communication chips). For example, the communication chip 1412 may be configured for managing wireless communications for the transfer of data to and from the computing device 1400. The term “wireless” and its derivatives may be used to describe circuits, devices, systems, methods, techniques, communications channels, etc., that may communicate data using modulated electromagnetic radiation through a nonsolid medium. The term does not imply that the associated devices do not contain any wires, although in some embodiments they might not.

The communication chip 1412 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication chip 1412 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication chip 1412 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 1412 may operate in accordance with code-division multiple access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 1412 may operate in accordance with other wireless protocols in other embodiments. The computing device 1400 may include an antenna 1422 to facilitate wireless communications and/or to receive other wireless communications (such as AM or FM radio transmissions).

In some embodiments, the communication chip 1412 may manage wired communications, such as electrical, optical, or any other suitable communication protocols (e.g., the Ethernet). As noted above, the communication chip 1412 may include multiple communication chips. For instance, a first communication chip 1412 may be dedicated to shorter-range wireless communications such as Wi-Fi or Bluetooth, and a second communication chip 1412 may be dedicated to longer-range wireless communications such as global positioning system (GPS), EDGE, GPRS, CDMA, WiMAX, LTE, EV-DO, or others. In some embodiments, a first communication chip 1412 may be dedicated to wireless communications, and a second communication chip 1412 may be dedicated to wired communications.

The computing device 1400 may include battery/power circuitry 1414. The battery/power circuitry 1414 may include one or more energy storage devices (e.g., batteries or capacitors) and/or circuitry for coupling components of the computing device 1400 to an energy source separate from the computing device 1400 (e.g., AC line power).

The computing device 1400 may include a display device 1406 (or corresponding interface circuitry, as discussed above). The display device 1406 may include any visual indicators, such as a heads-up display, a computer monitor, a projector, a touchscreen display, a liquid crystal display (LCD), a light-emitting diode display, or a flat panel display, for example.

The computing device 1400 may include an audio output device 1408 (or corresponding interface circuitry, as discussed above). The audio output device 1408 may include any device that generates an audible indicator, such as speakers, headsets, or earbuds, for example.

The computing device 1400 may include an audio input device 1418 (or corresponding interface circuitry, as discussed above). The audio input device 1418 may include any device that generates a signal representative of a sound, such as microphones, microphone arrays, or digital instruments (e.g., instruments having a musical instrument digital interface (MIDI) output).

The computing device 1400 may include a GPS device 1416 (or corresponding interface circuitry, as discussed above). The GPS device 1416 may be in communication with a satellite-based system and may receive a location of the computing device 1400, as known in the art.

The computing device 1400 may include another output device 1410 (or corresponding interface circuitry, as discussed above). Examples of the other output device 1410 may include an audio codec, a video codec, a printer, a wired or wireless transmitter for providing information to other devices, or an additional storage device.

The computing device 1400 may include another input device 1420 (or corresponding interface circuitry, as discussed above). Examples of the other input device 1420 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 1400 may have any desired form factor, such as a handheld or mobile computer system (e.g., a cell phone, a smart phone, a mobile internet device, a music player, a tablet computer, a laptop computer, a netbook computer, an ultrabook computer, a PDA (personal digital assistant), an ultramobile personal computer, etc.), a desktop computer system, a server or other networked computing component, a printer, a scanner, a monitor, a set-top box, an entertainment control unit, a vehicle control unit, a digital camera, a digital video recorder, or a wearable computer system. In some embodiments, the computing device 1400 may be any other electronic device that processes data.

### Selected Examples

The following paragraphs provide various examples of the embodiments disclosed herein.

Example 1 provides a method for deep learning, including storing a first element of an activation operand of a deep learning operation and a first element of a weight operand of the deep learning operation in one or more first storage units associated with a multiplier, where the multiplier computes a product by multiplying the first element of the activation operation with the first element of the weight operand; storing the product in a second storage unit; determining whether a second element of the activation operand or a second element of the weight operand is zero valued; after determining that the second element of the activation operand or the second element of the weight operand is zero valued, keeping the first element of the activation operand and the first element of the weight operand in the one or more first storage units; and writing a zero-valued data element into the second storage unit.

Example 2 provides the method of example 1, where determining whether the second element of the activation operand or the second element of the weight operand is zero valued includes performing a logical operation on the second element of the activation operand or the second element of the weight operand.

Example 3 provides the method of example 1 or 2, where determining whether the second element of the activation operand or the second element of the weight operand is zero valued includes determining whether the second element of the activation operand or the second element of the weight operand is zero valued based on an activation bitmap or a weight bitmap, where the activation bitmap includes a sequence of bits, each of which corresponds to a respective element of the activation operand and indicates whether the respective element of the activation operand is zero valued, and the weight bitmap includes a sequence of bits, each of which corresponds to a respective element of the weight operand and indicates whether the respective element of the weight operand is zero valued.

Example 4 provides the method of example 3, where determining whether the second element of the activation operand or the second element of the weight operand is zero valued includes performing a logical operation on a bit in the activation bitmap and a bit in the weight bitmap, the bit in the activation bitmap corresponding to the second element of the activation operand, the bit in the weight bitmap corresponding to the second element of the weight operand.

Example 5 provides the method of example 3 or 4, where determining whether the second element of the activation operand or the second element of the weight operand is zero valued includes computing a combined bitmap based on the activation bitmap and the weight bitmap, the combined bitmap including a sequence of bits, each of which is a product of a bit in the activation bitmap and a bit in the weight bitmap; and determining whether the second element of the activation operand or the second element of the weight operand is zero valued based on the combined bitmap.

Example 6 provides the method of any of the preceding examples, where determining whether the second element of the activation operand or the second element of the weight operand is zero valued includes determining whether a value of the second element of the activation operand or the second element of the weight operand is no greater than a threshold.

Example 7 provides the method of any of the preceding examples, where writing the zero-valued data element into the second storage unit includes writing the zero-valued data element into the second storage unit after a pipeline in the multiplier is completed.

Example 8 provides the method of any of the preceding examples, where after determining that the second element of the activation operand or the second element of the weight operand is zero valued, keeping the first element of the activation operand and the first element of the weight operand in the one or more first storage units includes in response to determining that the second element of the activation operand or the second element of the weight operand is zero valued, reducing gate switching for the deep learning operation.

Example 9 provides the method of any of the preceding examples, further including transmitting the product to an accumulator; and after determining that the second element of the activation operand or the second element of the weight operand is zero valued, disabling the accumulator.

Example 10 provides the method of any of the preceding examples, where the first element of the activation operand is arranged before the second element of the activation operand, the multiplier computes the product in a first clock cycle, the zero-valued data element is written into the second storage unit in a second clock cycle after the first clock cycle, and the first element of the activation operand and the first element of the weight operand are stored in the one or more first storage units in the first clock cycle and the second clock cycle.

Example 11 provides one or more non-transitory computer-readable media storing instructions executable to perform operations for in-network computing, the operations including storing a first element of an activation operand of a deep learning operation and a first element of a weight operand of the deep learning operation in one or more first storage units associated with a multiplier, where the multiplier computes a product by multiplying the first element of the activation operation with the first element of the weight operand; storing the product in a second storage unit; determining whether a second element of the activation operand or a second element of the weight operand is zero valued; after determining that the second element of the activation operand or the second element of the weight operand is zero valued, keeping the first element of the activation operand and the first element of the weight operand in the one or more first storage units; and writing a zero-valued data element into the second storage unit.

Example 12 provides the one or more non-transitory computer-readable media of example 11, where determining whether the second element of the activation operand or the second element of the weight operand is zero valued includes performing a logical operation on the second element of the activation operand or the second element of the weight operand.

Example 13 provides the one or more non-transitory computer-readable media of example 11 or 12, where determining whether the second element of the activation operand or the second element of the weight operand is zero valued includes determining whether the second element of the activation operand or the second element of the weight operand is zero valued based on an activation bitmap or a weight bitmap, where the activation bitmap includes a sequence of bits, each of which corresponds to a respective element of the activation operand and indicates whether the respective element of the activation operand is zero valued, and the weight bitmap includes a sequence of bits, each of which corresponds to a respective element of the weight operand and indicates whether the respective element of the weight operand is zero valued.

Example 14 provides the one or more non-transitory computer-readable media of any one of examples 11-13, where determining whether the second element of the activation operand or the second element of the weight operand is zero valued includes determining whether a value of the second element of the activation operand or the second element of the weight operand is no greater than a threshold.

Example 15 provides the one or more non-transitory computer-readable media of any one of examples 11-14, where writing the zero-valued data element into the second storage unit includes writing the zero-valued data element into the second storage unit after a pipeline in the multiplier is completed.

Example 16 provides the one or more non-transitory computer-readable media of any one of examples 11-15, where the operations further include transmitting the product to an accumulator; and after determining that the second element of the activation operand or the second element of the weight operand is zero valued, disabling the accumulator.

Example 17 provides an apparatus, including a computer processor for executing computer program instructions; and a non-transitory computer-readable memory storing computer program instructions executable by the computer processor to perform operations including storing a first element of an activation operand of a deep learning operation and a first element of a weight operand of the deep learning operation in one or more first storage units associated with a multiplier, where the multiplier computes a product by multiplying the first element of the activation operation with the first element of the weight operand, storing the product in a second storage unit, determining whether a second element of the activation operand or a second element of the weight operand is zero valued, after determining that the second element of the activation operand or the second element of the weight operand is zero valued, keeping the first element of the activation operand and the first element of the weight operand in the one or more first storage units, and writing a zero-valued data element into the second storage unit.

Example 18 provides the apparatus of example 17, where determining whether the second element of the activation operand or the second element of the weight operand is zero valued includes performing a logical operation on the second element of the activation operand or the second element of the weight operand.

Example 19 provides the apparatus of example 17 or 18, where determining whether the second element of the activation operand or the second element of the weight operand is zero valued includes determining whether the second element of the activation operand or the second element of the weight operand is zero valued based on an activation bitmap or a weight bitmap, where the activation bitmap includes a sequence of bits, each of which corresponds to a respective element of the activation operand and indicates whether the respective element of the activation operand is zero valued, and the weight bitmap includes a sequence of bits, each of which corresponds to a respective element of the weight operand and indicates whether the respective element of the weight operand is zero valued.

Example 20 provides the apparatus of any one of examples 17-19, where the operations further include transmitting the product to an accumulator; and after determining that the second element of the activation operand or the second element of the weight operand is zero valued, disabling the accumulator.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

1. A method for deep learning, comprising:
storing a first element of an activation operand of a deep learning operation and a first element of a weight operand of the deep learning operation in one or more first storage units associated with a multiplier, wherein the multiplier computes a product by multiplying the first element of the activation operation with the first element of the weight operand;
storing the product in a second storage unit;
determining whether a second element of the activation operand or a second element of the weight operand is zero valued;
after determining that the second element of the activation operand or the second element of the weight operand is zero valued, keeping the first element of the activation operand and the first element of the weight operand in the one or more first storage units; and
writing a zero-valued data element into the second storage unit.

2. The method of claim 1, wherein determining whether the second element of the activation operand or the second element of the weight operand is zero valued comprises:
performing a logical operation on the second element of the activation operand or the second element of the weight operand.

3. The method of claim 1, wherein determining whether the second element of the activation operand or the second element of the weight operand is zero valued comprises:
determining whether the second element of the activation operand or the second element of the weight operand is zero valued based on an activation bitmap or a weight bitmap, wherein:
the activation bitmap comprises a sequence of bits, each of which corresponds to a respective element of the activation operand and indicates whether the respective element of the activation operand is zero valued, and
the weight bitmap comprises a sequence of bits, each of which corresponds to a respective element of the weight operand and indicates whether the respective element of the weight operand is zero valued.

4. The method of claim 3, wherein determining whether the second element of the activation operand or the second element of the weight operand is zero valued comprises:
performing a logical operation on a bit in the activation bitmap and a bit in the weight bitmap, the bit in the activation bitmap corresponding to the second element of the activation operand, the bit in the weight bitmap corresponding to the second element of the weight operand.

5. The method of claim 3, wherein determining whether the second element of the activation operand or the second element of the weight operand is zero valued comprises:
computing a combined bitmap based on the activation bitmap and the weight bitmap, the combined bitmap comprising a sequence of bits, each of which is a product of a bit in the activation bitmap and a bit in the weight bitmap; and
determining whether the second element of the activation operand or the second element of the weight operand is zero valued based on the combined bitmap.

6. The method of claim 1, wherein determining whether the second element of the activation operand or the second element of the weight operand is zero valued comprises:
determining whether a value of the second element of the activation operand or the second element of the weight operand is no greater than a threshold.

7. The method of claim 1, wherein writing the zero-valued data element into the second storage unit comprises:
writing the zero-valued data element into the second storage unit after a pipeline in the multiplier is completed.

8. The method of claim 1, wherein after determining that the second element of the activation operand or the second element of the weight operand is zero valued, keeping the first element of the activation operand and the first element of the weight operand in the one or more first storage units comprises:
in response to determining that the second element of the activation operand or the second element of the weight operand is zero valued, reducing gate switching for the deep learning operation.

9. The method of claim 1, further comprising:
transmitting the product to an accumulator; and
after determining that the second element of the activation operand or the second element of the weight operand is zero valued, disabling the accumulator.

10. The method of claim 1, wherein:
the first element of the activation operand is arranged before the second element of the activation operand,
the multiplier computes the product in a first clock cycle,
the zero-valued data element is written into the second storage unit in a second clock cycle after the first clock cycle, and
the first element of the activation operand and the first element of the weight operand are stored in the one or more first storage units in the first clock cycle and the second clock cycle.

11. One or more non-transitory computer-readable media storing instructions executable to perform operations for in-network computing, the operations comprising:
storing a first element of an activation operand of a deep learning operation and a first element of a weight operand of the deep learning operation in one or more first storage units associated with a multiplier, wherein the multiplier computes a product by multiplying the first element of the activation operation with the first element of the weight operand;
storing the product in a second storage unit;
determining whether a second element of the activation operand or a second element of the weight operand is zero valued;
after determining that the second element of the activation operand or the second element of the weight operand is zero valued, keeping the first element of the activation operand and the first element of the weight operand in the one or more first storage units; and
writing a zero-valued data element into the second storage unit.

12. The one or more non-transitory computer-readable media of claim 11, wherein determining whether the second element of the activation operand or the second element of the weight operand is zero valued comprises:
performing a logical operation on the second element of the activation operand or the second element of the weight operand.

13. The one or more non-transitory computer-readable media of claim 11, wherein determining whether the second element of the activation operand or the second element of the weight operand is zero valued comprises:
determining whether the second element of the activation operand or the second element of the weight operand is zero valued based on an activation bitmap or a weight bitmap, wherein:
the activation bitmap comprises a sequence of bits, each of which corresponds to a respective element of the activation operand and indicates whether the respective element of the activation operand is zero valued, and
the weight bitmap comprises a sequence of bits, each of which corresponds to a respective element of the weight operand and indicates whether the respective element of the weight operand is zero valued.

14. The one or more non-transitory computer-readable media of claim 11, wherein determining whether the second element of the activation operand or the second element of the weight operand is zero valued comprises:
determining whether a value of the second element of the activation operand or the second element of the weight operand is no greater than a threshold.

15. The one or more non-transitory computer-readable media of claim 11, wherein writing the zero-valued data element into the second storage unit comprises:
writing the zero-valued data element into the second storage unit after a pipeline in the multiplier is completed.

16. The one or more non-transitory computer-readable media of claim 11, wherein the operations further comprise:
transmitting the product to an accumulator; and
after determining that the second element of the activation operand or the second element of the weight operand is zero valued, disabling the accumulator.

17. An apparatus, comprising:
a computer processor for executing computer program instructions; and
a non-transitory computer-readable memory storing computer program instructions executable by the computer processor to perform operations comprising:
storing a first element of an activation operand of a deep learning operation and a first element of a weight operand of the deep learning operation in one or more first storage units associated with a multiplier, wherein the multiplier computes a product by multiplying the first element of the activation operation with the first element of the weight operand,
storing the product in a second storage unit,
determining whether a second element of the activation operand or a second element of the weight operand is zero valued,
after determining that the second element of the activation operand or the second element of the weight operand is zero valued, keeping the first element of the activation operand and the first element of the weight operand in the one or more first storage units, and
writing a zero-valued data element into the second storage unit.

18. The apparatus of claim 17, wherein determining whether the second element of the activation operand or the second element of the weight operand is zero valued comprises:
performing a logical operation on the second element of the activation operand or the second element of the weight operand.

19. The apparatus of claim 17, wherein determining whether the second element of the activation operand or the second element of the weight operand is zero valued comprises:
determining whether the second element of the activation operand or the second element of the weight operand is zero valued based on an activation bitmap or a weight bitmap, wherein:
the activation bitmap comprises a sequence of bits, each of which corresponds to a respective element of the activation operand and indicates whether the respective element of the activation operand is zero valued, and
the weight bitmap comprises a sequence of bits, each of which corresponds to a respective element of the weight operand and indicates whether the respective element of the weight operand is zero valued.

20. The apparatus of claim 17, wherein the operations further comprise:
transmitting the product to an accumulator; and
after determining that the second element of the activation operand or the second element of the weight operand is zero valued, disabling the accumulator.
